(19) United States
(12) Patent Application Publication
(10) Pub. No.: US 2026/0003452 A1
(43) Pub. Date: Jan. 1, 2026

(54) VIRTUAL CAMERA CALIBRATION

(71) Applicant: TENCENT TECHNOLOGY (SHENZHEN) COMPANY LIMITED, Shenzhen (CN)

(72) Inventor: Xingbai CHEN, Shenzhen (CN)

(73) Assignee: TENCENT TECHNOLOGY (SHENZHEN) COMPANY LIMITED, Shenzhen (CN)

(21) Appl. No.: 19/318,308

(22) Filed: Sep. 3, 2025

Related U.S. Application Data
(63) Continuation of application No. PCT/CN2024/104156, filed on Jul. 8, 2024.

(30) Foreign Application Priority Data
Sep. 4, 2023 (CN) 202311137301.4

(51) Int. Cl. G06F 3/038; G06F 3/01; G06F 3/0346; G06T 11/00

(52) U.S. Cl. CPC G06F 3/038; G06F 3/011; G06F 3/0346; G06T 11/00; G06T 2207/30244

(57) ABSTRACT

In a virtual camera calibration method, a target object model of a physical camera device is obtained. The physical camera device includes a camera and a contact plane. The target object model with an operation controller is output for display through a head-mounted display device. The contact plane of the target object model and a contact plane of the operation controller are in an attached state. A camera position of the target object model corresponds to a camera position of the physical camera device. An indication that a camera of the target object model and the camera of the physical camera device are in an overlapping state is output for display. A virtual camera is calibrated based on spatial information of the operation controller and a spatial calibration operation for the virtual camera. The spatial information includes target position information and a target orientation.

### RELATED APPLICATIONS

The present application is a continuation of International Application No. PCT/CN2024/104156, filed on Jul. 8, 2024, which claims priority to Chinese Patent Application No. 202311137301.4, filed on Sep. 4, 2023. The entire disclosures of the prior applications are hereby incorporated by reference.

### FIELD OF THE TECHNOLOGY

This application relates to the field of extended reality technologies and the field of computer vision technologies including virtual camera calibration technologies.

### BACKGROUND OF THE DISCLOSURE

Mixed reality capture (MRC) refers to a recording technology that fuses content experienced by a user in extended reality (XR) with real-world actions of the user. In an MRC process, it is necessary to calibrate a physical shooting device and a virtual camera. This requires their positions and orientation angles to be as closely aligned as possible.

In related art, the user first fixes the position of the physical shooting device and locates the physical shooting device. Therefore, the position is also used as the position of the virtual camera. Then, the user puts on a head-mounted display device, picks up a VR controller, and faces the physical shooting device to capture an image 1. At the same time, the virtual camera captures an image 2. The user moves the image 2 so that the VR controller and the head-mounted display device in the image 1 overlap with those in the image 2. Finally, a trigonometric function is used to calculate a deflection angle, which is used to calibrate the orientation angle of the virtual camera.

However, in the process of calibrating the orientation angle of the virtual camera, inaccuracies in the orientation angle may require the user to take off and wear the head-mounted display device a plurality of times for repeated adjustments. This may lead to low efficiency in calibrating the orientation angle of the virtual camera, affecting user experience. In view of the foregoing problem, no effective solution has been provided yet.

### SUMMARY

Aspects of this disclosure provide a virtual camera calibration method, a virtual camera calibration apparatus, and a non-transitory computer-readable storage medium to eliminate the need for additional calculations during virtual camera calibration while achieving higher accuracy, thereby improving calibration efficiency of the virtual camera and enhancing user experience. Examples of technical solutions of this disclosure may be implemented as follows:

An aspect of this disclosure provides a virtual camera calibration method. In the method, a target object model of a physical camera device is obtained. The physical camera device includes a camera and has an associated contact plane. Through a head-mounted display device, the target object model with an operation controller is output for display to a user. The contact plane of the target object model and a contact plane of the operation controller are in an attached state. A camera position of the target object model corresponds to a camera position of the physical camera device. Based on the contact plane of the operation controller and the contact plane of the physical camera device being in the attached state, an indication that a camera of the target object model and the camera of the physical camera device are in an overlapping state is output for display through the head-mounted display device. A virtual camera is calibrated based on spatial information of the operation controller and a spatial calibration operation for the virtual camera. The spatial information includes target position information and a target orientation angle.

An aspect of this disclosure provides a virtual camera calibration apparatus. The apparatus includes processing circuitry configured to obtain a target object model of a physical camera device. The physical camera device includes a camera and has an associated contact plane. The processing circuitry is configured to output for display, through a head-mounted display device to a user, the target object model with an operation controller. The contact plane of the target object model and a contact plane of the operation controller are in an attached state. A camera position of the target object model corresponds to a camera position of the physical camera device. Based on the contact plane of the operation controller and the contact plane of the physical camera device being in the attached state, the processing circuitry is configured to output for display through the head-mounted display device, an indication that a camera of the target object model and the camera of the physical camera device are in an overlapping state. The processing circuitry is configured to calibrate a virtual camera based on spatial information of the operation controller and a spatial calibration operation for the virtual camera. The spatial information includes target position information and a target orientation angle.

An aspect of this disclosure provides a virtual camera calibration method. The method is performed by a computer device and includes: displaying, through a head-mounted display device when obtaining a target object model corresponding to a physical shooting device, the target object model linked with an operation controller, a contact plane of the target object model and a contact plane of the operation controller being in an attached state, and a camera position of the target object model having a correspondence with a camera position of the physical shooting device; displaying, through the head-mounted display device when a contact plane of the operation controller and a contact plane of the physical shooting device are in an attached state, that a camera of the target object model and a camera of the physical shooting device are in an overlapping state; and calibrating a virtual camera based on spatial information of the operation controller in response to a spatial calibration operation for the virtual camera, the spatial information including target position information and a target orientation angle.

Another aspect of this disclosure provides a virtual camera calibration method. The method is performed by a computer device and includes: obtaining, when a contact plane of an operation controller and a contact plane of a physical shooting device are in an attached state, target position information and a current orientation angle of the operation controller; determining a target orientation angle of the operation controller based on the current orientation angle and a plane normal vector of the operation controller, the plane normal vector representing a vector perpendicular to the contact plane of the operation controller; and calibrating a virtual camera based on the target position information and the target orientation angle of the operation controller.

Another aspect of this disclosure provides a virtual camera calibration apparatus. The apparatus is deployed on a computer device and includes: a display module, configured to: display, through a head-mounted display device when a target object model corresponding to a physical shooting device is obtained, the target object model linked with an operation controller, a contact plane of the target object model and a contact plane of the operation controller being in an attached state, and a camera position of the target object model having a correspondence with a camera position of the physical shooting device, the display module, being further configured to: display, through the head-mounted display device when the contact plane of the operation controller and a contact plane of the physical shooting device are in an attached state, that a camera of the target object model and a camera of the physical shooting device are in an overlapping state; and a calibration module, configured to calibrate the virtual camera based on spatial information of the operation controller in response to a spatial calibration operation for the virtual camera, the spatial information including target position information and a target orientation angle.

Another aspect of this disclosure provides a virtual camera calibration apparatus. The apparatus is deployed on a computer device and includes: an obtaining module, configured to obtain, when a contact plane of an operation controller and a contact plane of a physical shooting device are in an attached state, target position information and a current orientation angle of the operation controller; a determining module, configured to determine a target orientation angle of the operation controller based on the current orientation angle and a plane normal vector of the operation controller, the plane normal vector representing a vector perpendicular to the contact plane of the operation controller; and a calibration module, configured to calibrate a virtual camera based on the target position information and the target orientation angle of the operation controller.

Another aspect of this disclosure provides an extended reality device, including a display screen, a processor, a memory, and a communication module. The display screen is configured to provide a display function. The communication module is configured to establish a communication connection with a physical shooting device. The memory is configured to store a computer program. The processor is configured to: when executing the computer program, implement the methods according to the foregoing aspects.

Another aspect of this disclosure provides a computer device, including a memory and a processor. The memory has a computer program stored therein. The processor, when executing the computer program, implements the methods according to the foregoing aspects.

An aspect of this disclosure provides a non-transitory computer-readable storage medium, having computer-executable instructions stored therein, the computer-executable instructions, when executed by a processor, cause the processor to implement the methods according to the foregoing aspects.

Another aspect of this disclosure provides a computer program product, including a computer program. The computer program, when executed by a processor, implements the methods according to the foregoing aspects.

It can be seen from the foregoing technical solutions that the aspects of this disclosure have the following advantages.

In the aspects of this disclosure, a virtual camera calibration method is provided. First, a target object model linked with an operation controller is displayed through a head-mounted display device, where a camera position of the target object model has a correspondence with a camera position of a physical shooting device. When a contact plane of the operation controller and a contact plane of the physical shooting device are in an attached state, it indicates that a plane normal vector constructed based on the contact plane of the operation controller has the same orientation angle as the physical shooting device. The head-mounted display device is used to display that a camera of the target object model and a camera of the physical shooting device are in an overlapping state, that is, the camera position of the target object model overlaps with the camera position of the physical shooting device, which indicates that the position of the virtual camera is the camera position of the target object model. Based on this, when spatial calibration is required, the virtual camera can be calibrated based on spatial information of the operation controller in response to a spatial calibration operation for the virtual camera. Therefore, the virtual camera can be calibrated without requiring additional calculations, and higher accuracy can be achieved, thereby improving calibration efficiency of the virtual camera and enhancing user experience.

### BRIEF DESCRIPTION OF THE DRAWINGS

FIG. 1 is a schematic architectural diagram of implementing mixed reality capture according to an aspect of this disclosure.

FIG. 2 is a schematic diagram of an implementation environment of a virtual camera calibration method according to an aspect of this disclosure.

FIG. 3 is a schematic flowchart of a virtual camera calibration method according to an aspect of this disclosure.

FIG. 4 is a schematic diagram of linkage between a VR controller device and a target object model according to an aspect of this disclosure.

FIG. 5 is a schematic diagram of attachment between a VR controller device and a physical shooting device according to an aspect of this disclosure.

FIG. 6 is a related schematic diagram of prompting to attach a VR controller device to a physical shooting device according to an aspect of this disclosure.

FIG. 7 is a schematic diagram of presenting a first demonstration animation according to an aspect of this disclosure.

FIG. 8 is a schematic diagram of determining a plane normal vector based on a VR controller device according to an aspect of this disclosure.

FIG. 9 is a related schematic diagram of prompting to bring a VR controller device into contact with a camera of a physical shooting device according to an aspect of this disclosure.

FIG. 10 is a related schematic diagram of prompting to attach a VR controller device to a physical shooting device according to an aspect of this disclosure.

FIG. 11 is a schematic diagram of presenting a second demonstration animation according to an aspect of this disclosure.

FIG. 12 is a schematic diagram of detecting a device attached state based on pressure sensors according to an aspect of this disclosure.

FIG. 13 is a schematic diagram of enabling a see through function according to an aspect of this disclosure.

FIG. 14 is a schematic diagram of displaying a calibration prompt message according to an aspect of this disclosure.

FIG. 15 is a schematic comparison diagram of performing assisted attachment on a camera device according to an aspect of this disclosure.

FIG. 16 is a schematic diagram of implementing mixed reality capture according to an aspect of this disclosure.

FIG. 17 is another schematic flowchart of a virtual camera calibration method according to an aspect of this disclosure.

FIG. 18 is an overall schematic flowchart of virtual camera calibration according to an aspect of this disclosure.

FIG. 19 is a schematic diagram of a virtual camera calibration apparatus according to an aspect of this disclosure.

FIG. 20 is another schematic diagram of a virtual camera calibration apparatus according to an aspect of this disclosure.

FIG. 21 is a schematic structural diagram of a terminal according to an aspect of this disclosure.

### DETAILED DESCRIPTION

Aspects of this disclosure provide a virtual camera calibration method, a related apparatus, a device, and a storage medium, to eliminate the need for additional calculations during virtual camera calibration while achieving higher accuracy, thereby improving calibration efficiency of the virtual camera and enhancing user experience. The descriptions of the terms are provided as examples only and are not intended to limit the scope of the disclosure.

The terms such as “first”, “second”, “third”, and “fourth” (if any) in the specification and claims of this disclosure and in the accompanying drawings are configured for distinguishing between similar objects and not necessarily configured for describing any particular order or sequence. Data used in this way is interchangeable in a proper case, so that the aspects of this disclosure described herein can, for example, be implemented in an order other than those illustrated or described herein. In addition, the terms “include”, “corresponding to”, and any other variants thereof mean to cover non-exclusive inclusion. For example, a process, method, system, product, or device that includes a series of steps or units is not necessarily limited to those expressly listed steps or units, but may include other steps or units not expressly listed or inherent to the process, method, product, or device.

MRC can provide a more immersive and powerful viewing experience for people not wearing head-mounted display devices. Such functions not only introduce new ways to view XR applications, but also significantly improve user retention and potential sales, contributing to higher revenue. An MRC technology is configured for rendering third-person perspective views and fusing them with live-action views. In an application supporting MRC, scene logic is divided into two parts: foreground and background. After an MRC function is enabled, a head-mounted display device renders foreground content and background content of a current game state of a “first-person player” separately from a “third-person perspective”. Foreground and background image frames are encoded and then transmitted to a terminal (such as a mobile phone or a computer). The terminal performs portrait matting on a current camera stream, and then sequentially composites the background, the matted person, and the foreground into a final video.

In an MRC process, a key operation is calibrating a physical camera and a virtual camera. This requires positions and orientation angles of the physical shooting device and the virtual camera to be as closely aligned as possible. In this disclosure, a physical camera may be understood as a camera of a physical shooting device.

Based on this, this disclosure provides a virtual camera calibration method. An example in which an operation controller is a VR controller device, and the VR controller device is a ring-shaped VR controller device is used. The ring-shaped VR controller device has a ring that forms a plane, and a plane normal vector may be marked as an orientation angle 1. When a mobile phone is used as a real-world camera (namely, a physical shooting device), an orientation angle 2 of a camera (namely, a physical camera) of the mobile phone aligns with a plane normal vector of the mobile phone. When the user holds and attach the ring-shaped VR controller device to a plane of the mobile phone, the orientation angle 1 aligns with the orientation angle 2. In this case, orientation angles of the virtual camera and the camera of the mobile phone can be calibrated by recording an angle of the ring-shaped VR controller device in a virtual scene, thereby achieving a higher level of accuracy.

For the virtual camera calibration method provided in this disclosure, the MRC technology enables users to record themselves interacting in virtual scenes, making unshareable virtual reality (VR) views shareable. In the field of XR, it is widely used in a VR live streaming service, a game advertising service, a sharing service, and the like. Descriptions are provided below with reference to a game live streaming service.

First, the user needs to prepare a set of XR devices (including a head-mounted display device and a VR controller device), a mobile phone, and a tripod with a phone supporter. Based on this, the user starts the XR device and defines a sufficiently spacious safe play area, and selects a suitable position at an edge of the safe play area to fix the tripod. Then, the mobile phone is mounted securely, ensuring that the camera view of the mobile phone covers a shooting area. Next, an MRC recording application (APP) is started on the XR device side. In this case, an option in an assistant APP on a mobile phone end is selected to connect to the XR device. After the connection succeeds, the physical camera and the virtual camera can be calibrated. The calibration process can be carried out using the virtual camera calibration method provided in this disclosure. After the calibration is completed, the mobile phone displays an MRC recording interface, and the user may tap a record button to start recording. Therefore, the user returns to the safe play area and starts to play a game. After the game ends, the video may be saved on the mobile phone end.

The foregoing application scenario is only an example. The virtual camera calibration method provided in this aspect may be further applied to other scenarios, which is not limited herein.

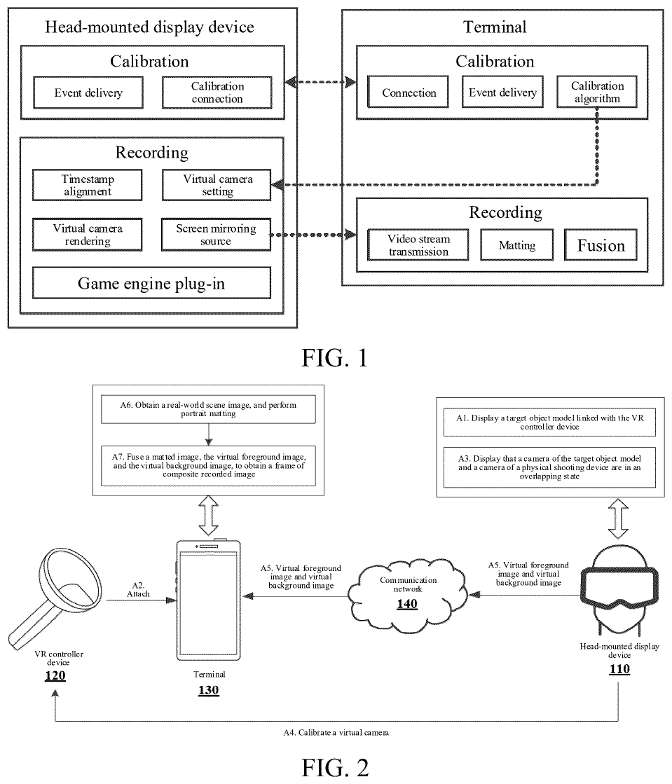

For ease of understanding, an MRC architecture is described below with reference to FIG. 1. FIG. 1 is a schematic architectural diagram of implementing mixed reality capture according to an aspect of this disclosure. As shown FIG. 1, a head-mounted display device and a terminal respectively include a calibration module and a recording module. The head-mounted display device establishes a communication connection with the terminal by accessing the same mobile hotspot (for example, Wi-Fi). After the devices are successfully connected, a process of aligning a virtual camera and a physical camera is triggered by a terminal. After the calibration is completed, the head-mounted display device transmits a video stream in the virtual scene to the terminal by using a wireless screen mirroring technology, and the terminal performs portrait matting on the video stream, to obtain a final video through fusion.

The MRC uses a deep learning-based matting model to matte a person from an environment and overlay the person into a virtual space. Therefore, a computer vision (CV) technology is involved. CV is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, the CV studies related theories and technologies and attempts to establish an artificial intelligence system that can obtain information from images or multidimensional data. The CV technologies include technologies such as image processing, image recognition, image semantic understanding, image retrieval, optical character recognition (OCR), video processing, video semantic understanding, video content/behavioral recognition, three-dimensional object reconstruction, a 3D technology, virtual reality, augmented reality, simultaneous positioning, and map construction, and further include related biometric recognition technologies such as face recognition and fingerprint recognition.

The method provided in this disclosure is applicable to an implementation environment shown in FIG. 2. The implementation environment includes an XR device and a terminal 130. The XR device includes a head-mounted display device 110 and a VR controller device 120. The XR device may communicate with the terminal 130 through a communication network 140. The communication network 140 uses standard communication technologies and/or protocols, and is usually the Internet, but may alternatively be any other network, including but not limited to, Bluetooth, a local area network (LAN), a metropolitan area network (MAN), a wide area network (WAN), or any combination of a mobile, a dedicated network, or a virtual dedicated network. In some aspects, the data communication technology may be replaced or supplemented by a customized or dedicated data communication technology.

The head-mounted display device 110 involved in this disclosure may also be referred to as a head-mounted display (HMD). By sending optical signals to eyes through the head-mounted display device 110, different effects such as VR, augmented reality (AR), and mixed reality (MR) can be achieved.

The VR controller device 120 involved in this disclosure belongs to an operation controller. Usually, the head-mounted display device 110 is provided with a VR controller device 120. A user may perform an operation by using the VR controller device 120, for example, by using a button, a touchpad, or a trigger, to complete an action in a virtual space.

The terminal 130 involved in this disclosure includes, but is not limited to, a mobile phone, a tablet computer, a laptop computer, a desktop computer, an intelligent voice interaction device, a smart home appliance, an in-vehicle terminal, an aircraft, and the like. A client is deployed on the terminal 130. The client may run on the terminal 130 in a form of a browser, or may run on the terminal 130 in a form of an independent APP.

With reference to the foregoing implementation environment, after a calibration mode is entered, in operation A1, the user can see, through the head-mounted display device 110, the target object model linked with the VR controller device 120. In operation A2, the user attaches a contact plane of the VR controller device 120 to a contact plane of the terminal 130. In this case, in operation A3, the user can see, through the head-mounted display device 110, that a camera of the target object model and a camera of the terminal 130 are in an overlapping state. Based on this, in operation A4, the user triggers a spatial calibration operation for the virtual camera, thereby implementing calibration of the virtual camera.

After a recording mode is entered, in operation A5, the head-mounted display device 110 sends a virtual scene video stream to the terminal 130 through the communication network 140. The virtual scene video stream includes a plurality of frames of virtual foreground images and a plurality of frames of virtual background images. At the same time, in operation A6, the terminal 130 records a real-world scene video stream. The real-world scene video stream includes a plurality of frames of real-world scene images. The terminal 130 invokes the deep learning-based matting model to perform portrait matting on each frame of real-world scene image, to obtain each frame of matted image. In operation A7, the terminal 130 fuses the matted image, the virtual foreground image, and the virtual background image that correspond to the same timestamp, to obtain a frame of composite recorded image. A composite video stream is obtained based on the frames of composite recorded images.

The virtual camera calibration method provided in the aspects of this disclosure may be implemented by a computer device. The computer device may be an XR device, or an XR device and a terminal, or an XR device, a terminal, and a server. The server may be an independent physical server, or may be a server cluster or a distributed system including a plurality of physical servers, or may be a cloud server that provides cloud computing services. The terminal may be a smart phone, a tablet computer, a notebook computer, and the like, but is not limited thereto. The terminal and the server may be directly or indirectly connected in a wired or wireless communication manner, which is not limited in this disclosure.

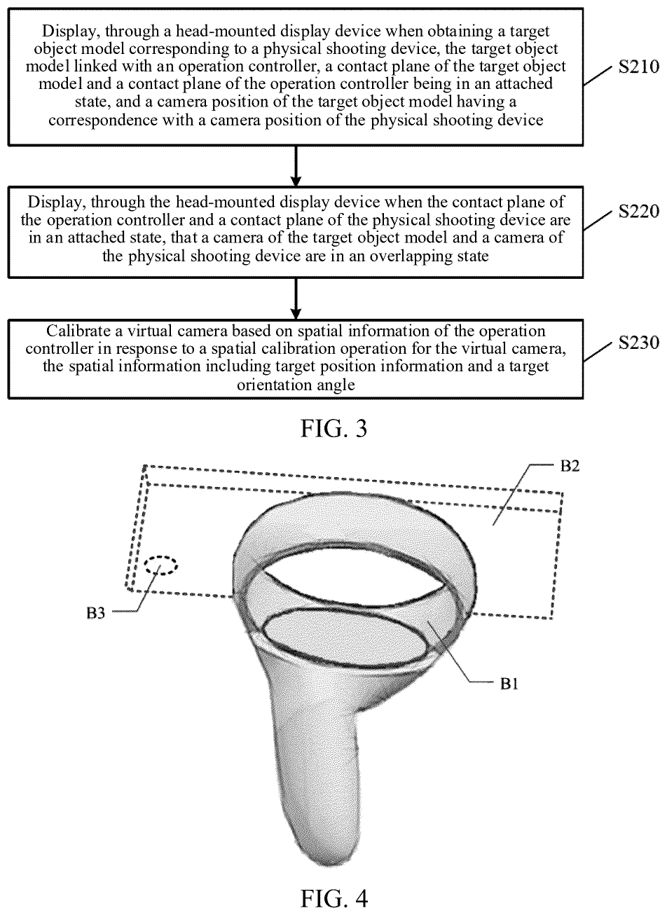

With reference to the foregoing descriptions, the virtual camera calibration method in this disclosure is described below. Referring to FIG. 3, the virtual camera calibration method in the aspects of this disclosure may be performed independently by an XR device, may be performed cooperatively by an XR device and a terminal, or may be performed cooperatively by an XR device, a terminal, and a server. The method in this disclosure includes the following operations.

210: Display, through a head-mounted display device when obtaining a target object model corresponding to a physical shooting device, the target object model linked with an operation controller, a contact plane of the target object model and a contact plane of the operation controller being in an attached state, and a camera position of the target object model having a correspondence with a camera position of the physical shooting device. For example, a target object model of a physical camera device is obtained. The physical camera device includes a camera and has an associated contact plane. Through a head-mounted display device, the target object model with an operation controller is output for display to a user. The contact plane of the target object model and a contact plane of the operation controller are in an attached state. A camera position of the target object model corresponds to a camera position of the physical camera device.

In one or more aspects, a user may select a target object model through a terminal, and an appearance of a physical shooting device can be simulated using the target object model. In other words, the target object model is a model simulating the appearance of the physical shooting device. Based on this, the user may display, through the head-mounted display device, the target object model linked with the operation controller. The head-mounted display device involved in this disclosure may be an XR device capable of achieving different effects such as VR, AR, and MR. The physical shooting device involved in this disclosure may be an actual hardware device configured to capture an image or a video, and is configured to capture a real-world scene image. The physical shooting device may be a terminal (for example, a mobile phone or a tablet computer), or may be an independent camera device. This is not limited herein.

The operation controller may be an input device interacting with the virtual scene. The type of the operation controller is not limited in this aspect of this disclosure, and may be, for example, a VR controller device or a glove-style controller. The VR controller device may be a VR controller device of various shapes, for example, may be a ring-shaped VR controller device.

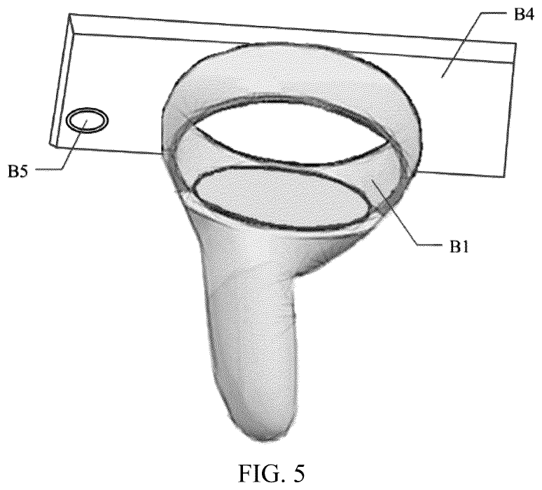

For ease of understanding, an example in which the operation controller is a VR controller device is used. FIG. 4 is a schematic diagram of linkage between a VR controller device and a target object model according to an aspect of this disclosure. As shown in FIG. 4, B1 is configured for indicating the VR controller device, where a ring-shaped surface of the VR controller device belongs to a contact plane of the VR controller device. B2 is configured for indicating the target object model. B3 is configured for indicating a camera of the target object model. Because the target object model can simulate the appearance of the physical shooting device, the camera position of the target object model has a correspondence with the camera position of the physical shooting device. In other words, the camera position of the target object model is the same as or close to the camera position of the physical shooting device (for example, a deviation range is less than or equal to 3 mm).

Because the contact plane of the target object model and the contact plane of the VR controller device remain in the attached state, when the VR controller device moves, the target object model moves correspondingly. A Quest platform using a Unity engine is used as an example. Before calibration of a virtual camera, a target object model is attached to a contact plane of a VR controller device. In other words, a cuboid model is attached to and placed on a contact plane (for example, a ring-shaped surface) of a VR controller model node as the target object model. At an initial moment, the target object model uses the VR controller model node as a parent node. Therefore, a position of the target object model relative to the VR controller device remains unchanged, and the target object model remains attached to the contact plane of the VR controller device.

Developing an application on the Quest platform requires its software development kit (SDK). The SDK is a software library that includes some platform interfaces and resources. For example, whether a button of a VR controller is pressed and an official model of the VR controller can be obtained by using the SDK.

220: Display, through the head-mounted display device when the contact plane of the operation controller and a contact plane of the physical shooting device are in an attached state, that a camera of the target object model and a camera of the physical shooting device are in an overlapping state. For example, based on the contact plane of the operation controller and the contact plane of the physical camera device being in the attached state, an indication that a camera of the target object model and the camera of the physical camera device are in an overlapping state is output for display through the head-mounted display device.

In one or more aspects, the target object model may guide the user to attach the operation controller to the physical shooting device, thereby achieving a better interaction effect. Based on a see through technology, the user can see an augmented reality scene through the head-mounted display device. Based on this, the user may attach the operation controller to the physical shooting device. When the operation controller is accurately attached to the physical shooting device, the user can see, through the head-mounted display device, that the camera of the target object model and the camera of the physical shooting device are in the overlapping state. The “overlapping state” involved above may be a complete overlap (that is, a 100% overlap), or may be an overlap greater than a specific threshold (for example, an overlap rate of greater than 95%).

See through refers to a technology that allows a forward camera in the head-mounted display device to capture a real-world scene and display it on a screen in real time, enabling the user to see the real-world scene when wearing the head-mounted display device.

For ease of understanding, an example in which the operation controller is a VR controller device is used. FIG. 5 is a schematic diagram of attachment between a VR controller device and a physical shooting device according to an aspect of this disclosure. As shown in FIG. 5, B1 is configured for indicating a VR controller device, where a ring-shaped surface of the VR controller device belongs to a contact plane of the VR controller device. B4 is configured for indicating a physical shooting device. B5 is configured for indicating a camera of the physical shooting device. When the VR controller device is accurately attached to the physical shooting device, the camera of the physical shooting device indicated by B5 and the camera of the target object model indicated by B3 in FIG. 4 are in the overlapping state.

230: Calibrate the virtual camera based on spatial information of the operation controller in response to a spatial calibration operation for the virtual camera, the spatial information including target position information and a target orientation angle. For example, a virtual camera is calibrated based on spatial information of the operation controller and a spatial calibration operation for the virtual camera. The spatial information includes target position information and a target orientation angle.

In one or more aspects, if the contact plane of the operation controller and the contact plane of the physical shooting device are in the attached state, and the camera of the target object model and the camera of the physical shooting device are in the overlapping state, the user may trigger a specific button event using the operation controller, thereby triggering a spatial calibration operation for the virtual camera. Therefore, the parent node of the target object model is updated as a scene root node. Based on this, in the virtual scene, the target object model no longer follows the operation controller, but its relative position in the scene remains unchanged. Therefore, in this case, position information of the camera of the target object model is position information of the virtual camera, and an orientation angle of the operation controller is an orientation angle of the virtual camera.

The camera position of the target object model is preset. Transformation information (transform) of the operation controller in a world coordinate system can be directly obtained by using a related method in an XR development platform SDK. The transformation information includes target position information (position) and a current orientation angle (rotation). Based on this, the position information of the camera of the target object model in the world coordinate system may be deduced based on a position relationship between the camera position of the target object model and the VR controller model, and target position information of the operation controller in the world coordinate system. In addition, the target orientation angle of the operation controller may be calculated based on the current orientation angle of the operation controller and a plane normal vector of the operation controller. The plane normal vector represents a vector perpendicular to the contact plane of the operation controller.

Based on the spatial information of the operation controller, the position information of the camera of the target object model in the world coordinate system may be deduced. Therefore, the position information of the camera of the target object model in the world coordinate system is used as the position information of the virtual camera in the world coordinate system. In addition, the target orientation angle of the operation controller may be calculated, and the target orientation angle is used as an orientation angle of the virtual camera in the world coordinate system.

“In response to” involved in this disclosure is configured for representing a condition or a state on which a to-be-performed operation depends. When the condition or the state is satisfied, one or more operations may be performed. The one or more operations may be real-time or may experience some latency.

This aspect of this disclosure provides a virtual camera calibration method. In the foregoing manner, calibration of the virtual camera may be implemented based on the position information and the orientation angle of the operation controller. This eliminates the need for additional calculations during virtual camera calibration while achieving higher accuracy, thereby improving calibration efficiency of the virtual camera.

There may be a plurality of models of physical shooting devices, and physical shooting devices of different models may have different appearances. Therefore, corresponding object models may be created for physical shooting devices of different models. Therefore, to improve accuracy of the target object model, the target object model may be obtained based on model information of the physical shooting device.

Object models of physical shooting devices of different models may be stored at different positions, for example, locally or at a server. Based on different storage manners, manners of obtaining the target object model based on the model information of the physical shooting device may be different. Based on one or more aspects corresponding to FIG. 3, in another aspect provided in the disclosure, before the displaying, through a head-mounted display device when a target object model corresponding to a physical shooting device is obtained, the target object model linked with an operation controller, the method may further include:
obtaining the target object model corresponding to the physical shooting device from a locally stored model resource set in response to a model invocation request, the model invocation request carrying model information of the physical shooting device, the model resource set including at least one object model, each object model corresponding to one piece of model information, and the target object model corresponding to the model information carried in the model invocation request.

In one or more aspects, a manner of determining the target object model is described. It can be known from the foregoing aspects that, the physical shooting device or the terminal may read the model information of the physical shooting device, and send the model invocation request carrying the model information to the XR device. If the physical shooting device and the terminal (for example, a mobile phone or a tablet computer) are the same device, the physical shooting device sends the model information of the physical shooting device to the XR device. If the physical shooting device (for example, an external camera) and the terminal (for example, a mobile phone or a tablet computer) are not the same device, after the physical shooting device establishes a communication connection with the terminal, the terminal may read the model information of the physical shooting device, and send the model information of the physical shooting device to the XR device.

After receiving the model invocation request, the XR device first parses the model invocation request, to obtain the model information of the physical shooting device. Then, the locally stored model resource set is queried, based on the model information of the physical shooting device, for whether an object model corresponding to the model information of the physical shooting device exists. If an object model corresponding to the model information of the physical shooting device exists, the object model is used as the target object model.

This aspect of this disclosure provides a manner of determining the target object model. In the foregoing manner, the XR device locally reads the object model corresponding to the model information, to obtain the target object model matching the appearance of the physical shooting device, thereby obtaining more accurate position information.

Based on one or more aspects corresponding to FIG. 3, in another aspect provided in this disclosure, before the displaying, through a head-mounted display device when a target object model corresponding to a physical shooting device is obtained, the target object model linked with an operation controller, the method may further include: p1 sending a model download request to a server in response to a model invocation request, the model invocation request carrying model information of the physical shooting device, and the model download request carrying the model information of the physical shooting device; and
receiving the target object model corresponding to the physical shooting device that is sent by the server, the target object model corresponding to the model information carried in the model download request.

In one or more aspects, another manner of determining the target object model is described. It can be known from the foregoing aspects that, the physical shooting device or the terminal may read the model information of the physical shooting device, and send the model invocation request carrying the model information to the XR device.

After receiving the model invocation request, the XR device first parses the model invocation request, to obtain the model information of the physical shooting device. Then, the model information of the physical shooting device is encapsulated into the model download request, and the model download request is sent to the server. Based on this, after receiving the model download request, the server parses the model download request, to obtain the model information of the physical shooting device. Therefore, the server queries, based on the model information of the physical shooting device, the model resource set for whether an object model corresponding to the model information of the physical shooting device exists. If an object model corresponding to the model information of the physical shooting device exists, the object model is used as the target object model. Finally, the server feeds back the target object model to the XR device.

This aspect of this disclosure provides another manner of determining the target object model. In the foregoing manner, the XR device downloads the object model matching the model information from the server. The target object model matching the appearance of the physical shooting device can be obtained, thereby obtaining more accurate position information. In addition, various object models are stored on the server side, so that local storage resources of the XR device can be saved, thereby helping optimize performance of the XR device.

Based on one or more aspects corresponding to FIG. 3, in another aspect provided in this disclosure, after the displaying, through a head-mounted display device when a target object model corresponding to a physical shooting device is obtained, the target object model linked with an operation controller, the method may further include:
displaying a first prompt message through the head-mounted display device, the first prompt message being configured for prompting to attach the contact plane of the operation controller to the contact plane of the physical shooting device and align the target object model with the physical shooting device;
or
playing a first voice message through the head-mounted display device, the first voice message being configured for prompting to attach the contact plane of the operation controller to the contact plane of the physical shooting device and align the target object model with the physical shooting device;
or
displaying the first prompt message through the head-mounted display device and playing the first voice message.

In one or more aspects, a manner of prompting the user to perform related operations when using the target object model is described. It can be known from the foregoing aspects that based on the see through technology, the user can see an augmented reality scene through the head-mounted display device. Therefore, the augmented reality scene can guide the user to perform the related operations. Based on this, after the user sees the target object model linked with the operation controller, a related prompt may be provided, to guide the user to attach the contact plane of the operation controller to the contact plane of the physical shooting device.

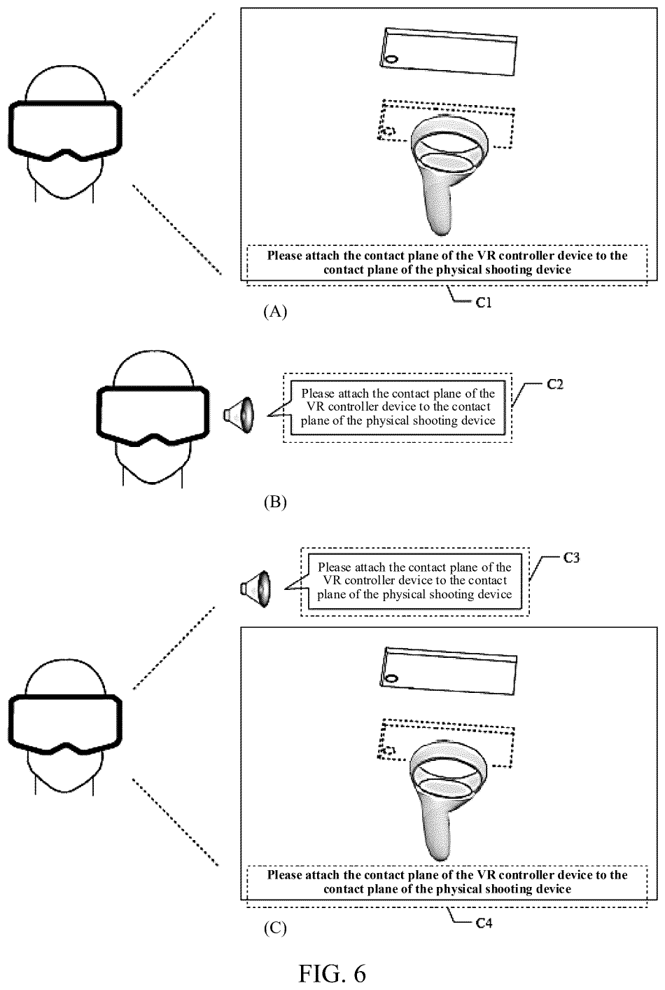

Different prompt manners are respectively described below with reference to FIG. 6 by using an example in which the operation controller is a VR controller device. FIG. 6 is a related schematic diagram of prompting to attach a VR controller device to a physical shooting device according to an aspect of this disclosure.

### Manner 1: Interface Prompt

During implementation, referring to FIG. 6(A), C1 is configured for indicating a first prompt message. After enabling a see through function, the user can not only see, through the head-mounted display device, the target object model linked with the VR controller device, but also see the physical shooting device. Based on this, the first prompt message indicated by C1 can guide the user to attach the contact plane of the VR controller device to the contact plane of the physical shooting device. When the attachment is accurate, the camera of the target object model and the camera of the physical shooting device are in the overlapping state.

### Manner 2: Voice Prompt

During implementation, referring to FIG. 6(B), C2 is configured for indicating a first voice message. After enabling the see through function, the user can see, through the head-mounted display device, the target object model linked with the VR controller device and the physical shooting device. Based on this, the first voice message indicated by C2 can guide the user to attach the contact plane of the VR controller device to the contact plane of the physical shooting device. When the attachment is accurate, the camera of the target object model and the camera of the physical shooting device are in the overlapping state.

### Manner 3: Combining the Interface Prompt and the Voice Prompt

During implementation, referring to FIG. 6(C), C3 is configured for indicating the first voice message, and C4 is configured for indicating the first prompt message. After enabling a see through function, the user can see, through the head-mounted display device, the target object model linked with the VR controller device and the physical shooting device. Based on this, the first voice message indicated by C3 and the first prompt message indicated by C4 can guide the user to attach the contact plane of the VR controller device to the contact plane of the physical shooting device. When the attachment is accurate, the camera of the target object model and the camera of the physical shooting device are in the overlapping state.

This aspect of this disclosure provides a manner of prompting a user to perform related operations when using the target object model. In the foregoing manner, a related prompt for attaching the operation controller to the physical shooting device may be provided to the user through the head-mounted display device. Therefore, the user can be more intuitively guided to perform correct operations, thereby reducing learning costs, and further helping improve the virtual camera calibration effect.

Based on one or more aspects corresponding to FIG. 3, in another aspect provided in this disclosure, the method may further include:
displaying a first demonstration animation through the head-mounted display device, the first demonstration animation being configured for guiding a process of calibrating the virtual camera using the operation controller.

In one or more aspects, a manner of playing a demonstration animation when using the target object model is described. It can be known from the foregoing aspects that, before calibrating the virtual camera, the user may view the related first demonstration animation through the head-mounted display device or the terminal. Through the first demonstration animation, the user can more intuitively learn how to calibrate the virtual camera. Related content of the first demonstration animation is described below with reference to the figures.

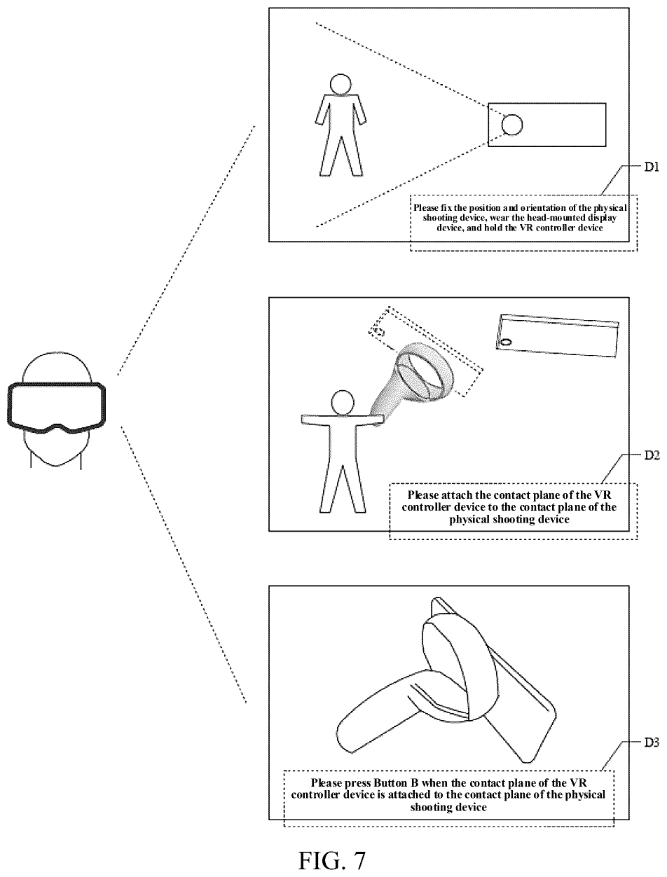

An example in which the operation controller is a VR controller device is used. For ease of understanding, FIG. 7 is a schematic diagram of presenting a first demonstration animation according to an aspect of this disclosure. As shown in FIG. 7, the first demonstration animation prompts, through information indicated by D1, the user to first fix a position and an orientation angle of the physical shooting device, wear the head-mounted display device, and hold the VR controller device, to enter a virtual scene. The prompt content indicated by D1 may be presented in a text form or a voice form. Next, the first demonstration animation prompts, through information indicated by D2, the user to attach the contact plane of the VR controller device to the contact plane of the physical shooting device. Finally, the first demonstration animation prompts, through information indicated by D3, the user to press Button B of the VR controller device when the contact plane of the VR controller device is attached to the contact plane of the physical shooting device, to implement automatic calibration of the virtual camera.

“Button B” of the VR controller device is merely an example. In practical applications, the user may customize other buttons of the VR controller device as “Button B”, which is not limited herein.

This aspect of this disclosure provides a manner of playing a demonstration animation when using the target object model. In the foregoing manner, the demonstration animation is used to guide the user through the process of calibrating the virtual camera using the target object model. The demonstration animation improves the user's understanding through visual experience, and helps the user understand the calibration process in a simple and easy manner, thereby improving information transmission efficiency.

Based on one or more aspects corresponding to FIG. 3, in another aspect provided in this disclosure, the calibrating the virtual camera based on spatial information of the operation controller in response to a spatial calibration operation for the virtual camera may include:
obtaining target position information and a current orientation angle of the operation controller in response to the spatial calibration operation for the virtual camera;
determining position information of the virtual camera based on the target position information and a camera position of the target object model;
determining the target orientation angle of the operation controller based on the current orientation angle and the plane normal vector of the operation controller, the plane normal vector representing a vector perpendicular to the contact plane of the operation controller; and
calibrating the virtual camera using the position information of the virtual camera and the target orientation angle.

In one or more aspects, a manner of calibrating the virtual camera when using the target object model is described. It can be known from the foregoing aspects that when the contact plane of the operation controller and the contact plane of the physical shooting device are in the attached state, and the camera of the target object model and the camera of the physical shooting device are in the overlapping state, the user may trigger a spatial calibration operation for the virtual camera. Based on this, by invoking an “object.getTransform” interface based on the Unity engine, the transformation information of the operation controller in the world coordinate system may be obtained, that is, the target position information and the current orientation angle of the operation controller in the world coordinate system are obtained.

The “position information” involved in this disclosure may be represented as coordinates (x, y, z), and the “orientation angle” in this disclosure may be represented as Euler angles (xAngle, yAngle, zAngle). Manners of determining the position information of the virtual camera and the orientation angle of the virtual camera are respectively described below.

### 1. The Position Information of the Virtual Camera

Because the camera position of the target object model is preset, when the camera of the target object model overlaps with the camera of the physical shooting device, the camera position of the target object model can be directly used as the camera position of the physical shooting device. In addition, because a position relationship between the target object model and a VR controller model is also preset, a position offset (that is, an offset in three directions, namely, an X-axis, a Y-axis, and a Z-axis) between the camera position of the target object model and the operation controller is also known.

In conclusion, when the camera of the target object model overlaps with the camera of the physical shooting device, offset calculation is performed on target position information of the operation controller in the world coordinate system based on the position offset between the camera position of the target object model and the operation controller, to obtain the position information of the camera of the target object model in the world coordinate system. Assuming that the position offset is represented as (Δx, Δy, Δz), and the target position information is represented as (xₜ, yₜ, zₜ), the position information of the camera of the target object model in the world coordinate system may be represented as (xₜ+Δx, yₜ+Δy, zₜ+Δz).

The position information of the camera of the target object model in the world coordinate system is the position information of the camera of the physical shooting device in the world coordinate system. Therefore, the position information of the camera of the physical shooting device in the world coordinate system may also be represented as (xₜ+Δx, yₜ+Δy, zₜ+Δz). When position calibration is performed on the virtual camera, position information of the virtual camera in the world coordinate system needs to be aligned with position information of the camera of the physical shooting device in the world coordinate system. Therefore, the position calibration of the virtual camera can be completed by directly using the position information of the camera of the physical shooting device in the world coordinate system as the position information of the virtual camera in the world coordinate system.

### 2. The Orientation Angle of the Virtual Camera

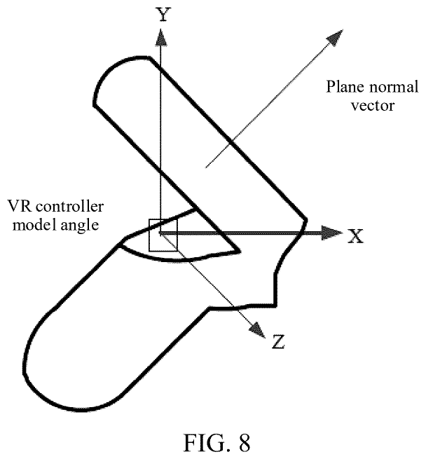

An example in which the operation controller is a VR controller device is used. For ease of understanding, FIG. 8 is a schematic diagram of determining a plane normal vector based on a VR controller device according to an aspect of this disclosure. As shown in FIG. 8, a ring-shaped VR controller device is used as an example. The ring-shaped VR controller device has a ring that forms a contact plane of the VR controller device. The plane normal vector is a vector perpendicular to the contact plane of the VR controller device, and the plane normal vector forms a fixed angle with an initial orientation angle of the VR controller device. Therefore, the plane normal vector may be obtained by calculating a cosine value between a rotation angle component of the plane normal vector and a rotation angle component of the VR controller device.

A process of calculating the target orientation angle of the VR controller device is described below with reference to an example.

It is assumed that the initial orientation angle of the VR controller device is represented as “rotation_init”. The initial orientation angle may be set to (0, 0, 0). The initial orientation angle of the VR controller device is an orientation angle of the VR controller device captured at a startup moment of the XR device.

It is assumed that the plane normal vector is represented as “n”. The plane normal vector may be set to “(x1, y1, z1)”.

It is assumed that the current orientation angle of the VR controller device is represented as “rotation_ct”. The current orientation angle may be set to (angle_x, angle_y, angle_z). The current orientation angle of the VR controller device is an orientation angle of the VR controller device captured when the user triggers a spatial calibration operation.

It is assumed that the target orientation angle of the VR controller device in the world coordinate system is represented as “n_rotated”.

First, the plane normal vector is transformed into a unit vector (that is, a normalized vector) in the following manner:

$$n\_normalized = n / ‖ n ‖ ; \qquad formula ( 1 )$$

n_normalized represents the unit vector. n represents a plane normal vector.

Then, a rotation matrix of the VR controller device is calculated in the following manner:

$${R}_{x} = [ \begin{matrix}1 & 0 & 0 \\ 0 & cos ( angle\_x ) & - sin ( angle\_x ) \\ 0 & sin ( angle\_x ) & cos ( angle\_x )\end{matrix} ] ; \qquad formula ( 2 )$$

$${R}_{y} = [ \begin{matrix}cos ( angle\_y ) & 0 & sin ( angle\_y ) \\ 0 & 1 & 0 \\ - sin ( angle\_y ) & 0 & cos ( angle\_y )\end{matrix} ] ; \qquad formula ( 3 )$$

$${R}_{z} = [ \begin{matrix}cos ( angle\_z ) & - sin ( angle\_z ) & 0 \\ sin ( angle\_z ) & cos ( angle\_z ) & 0 \\ 0 & 0 & 1\end{matrix} ] ; \qquad formula ( 4 )$$

Rₓ represents a rotation matrix corresponding to rotation of the VR controller device by the angle_x around the X-axis direction. R_{y} represents a rotation matrix corresponding to rotation of the VR controller device by the angle_y around the Y-axis direction. R_{z} represents a rotation matrix corresponding to rotation of the VR controller device by the angle_z around the Z-axis direction. (angle_x, angle_y, angle_z) represents the current orientation angle.

Therefore, the rotation matrices are multiplied sequentially in the following manner, to obtain a final target rotation matrix:

$$R = {R}_{z}^{*} {R}_{y}^{*} {R}_{x} ; \qquad formula ( 5 )$$

R represents the target rotation matrix.

Finally, the target orientation angle of the VR controller device is calculated in the following manner:

$$n\_rotated = R * n\_normalized ; \qquad formula ( 6 )$$

n_rotated represents the target orientation angle of the VR controller device in the world coordinate system. R represents the target rotation matrix. n_normalized represents the unit vector.

The target orientation angle of the VR controller device in the world coordinate system is the orientation angle of the camera of the physical shooting device in the world coordinate system. When the orientation angle calibration is performed on the virtual camera, the orientation angle of the virtual camera in the world coordinate system needs to be aligned with the orientation angle of the camera of the physical shooting device in the world coordinate system. Therefore, the orientation angle calibration of the virtual camera can be completed by directly using the target orientation angle of the VR controller device in the world coordinate system as the orientation angle of the virtual camera in the world coordinate system.

This aspect of this disclosure provides a manner of calibrating the virtual camera when using the target object model. In the foregoing manner, the position information of the virtual camera can be directly determined by using the known target position information and the camera position of the target object model. In addition, the orientation angle of the virtual camera can be calculated by using the known current orientation angle and the plane normal vector. It can be seen that the operations of calibrating the virtual camera are relatively simple, requiring no additional calculations, and a more accurate calibration effect can be achieved.

Based on one or more aspects corresponding to FIG. 3, in another aspect provided in this disclosure, the method may further include:
obtaining, if the target object model corresponding to the physical shooting device is not obtained, the target position information of the operation controller in response to a position recording operation for the operation controller when the operation controller is in contact with the camera of the physical shooting device;
obtaining the target orientation angle of the operation controller in response to an angle recording operation for the operation controller when the contact plane of the operation controller is attached to the contact plane of the physical shooting device; and
calibrating the virtual camera based on the target position information and the target orientation angle.

In one or more aspects, a manner of calibrating the virtual camera without the target object model is described. It can be known from the foregoing aspects that if the target object model matching the physical shooting device cannot be found, the target position information of the operation controller in the world coordinate system needs to be additionally recorded. In this case, the target position information is the position information of the camera of the physical shooting device in the world coordinate system.

During implementation, the user may bring the operation controller into contact with the camera of the physical shooting device, and trigger a position recording operation for the operation controller when the operation controller comes into contact with the camera of the physical shooting device, to obtain the target position information of the operation controller. In addition, the user further needs to attach the contact plane of the operation controller to the contact plane of the physical shooting device, and trigger an angle recording operation for the operation controller when the contact plane of the physical shooting device is attached to the contact plane of the physical shooting device, to obtain the current orientation angle of the operation controller.

The target position information of the operation controller may be directly used as the position information of the virtual camera in the world coordinate system. In addition, the target orientation angle of the operation controller may be calculated based on the current orientation angle and the plane normal vector. Therefore, the target orientation angle is used as the orientation angle of the virtual camera in the world coordinate system.

This aspect of this disclosure provides a manner of calibrating the virtual camera without the target object model. In the foregoing manner, if the target object model matching the physical shooting device cannot be obtained, the operation controller may be used to touch the camera of the physical shooting device, to locate the camera position of the physical shooting device. In this way, the flexibility and operability of the solution are improved.

Based on one or more aspects corresponding to FIG. 3, in another aspect provided in this disclosure, before the obtaining the target position information of the operation controller in response to a position recording operation for the operation controller when the operation controller is in contact with the camera of the physical shooting device, the method may further include:
displaying a second prompt message through the head-mounted display device, the second prompt message being configured for prompting to bring the operation controller into contact with the camera of the physical shooting device;
or
playing a second voice message through the head-mounted display device, the second voice message being configured for prompting to bring the operation controller into contact with the camera of the physical shooting device;
or
displaying the second prompt message through the head-mounted display device and playing the second voice message.

In one or more aspects, a manner of prompting the user to perform a position recording operation is described. It can be known from the foregoing aspects that based on the see through technology, the user can see an augmented reality scene through the head-mounted display device. Therefore, the augmented reality scene can guide the user to perform the related operations. Based on this, before the user triggers the position recording operation, a related prompt may be provided, to guide the user to bring the operation controller into contact with the camera of the physical shooting device.

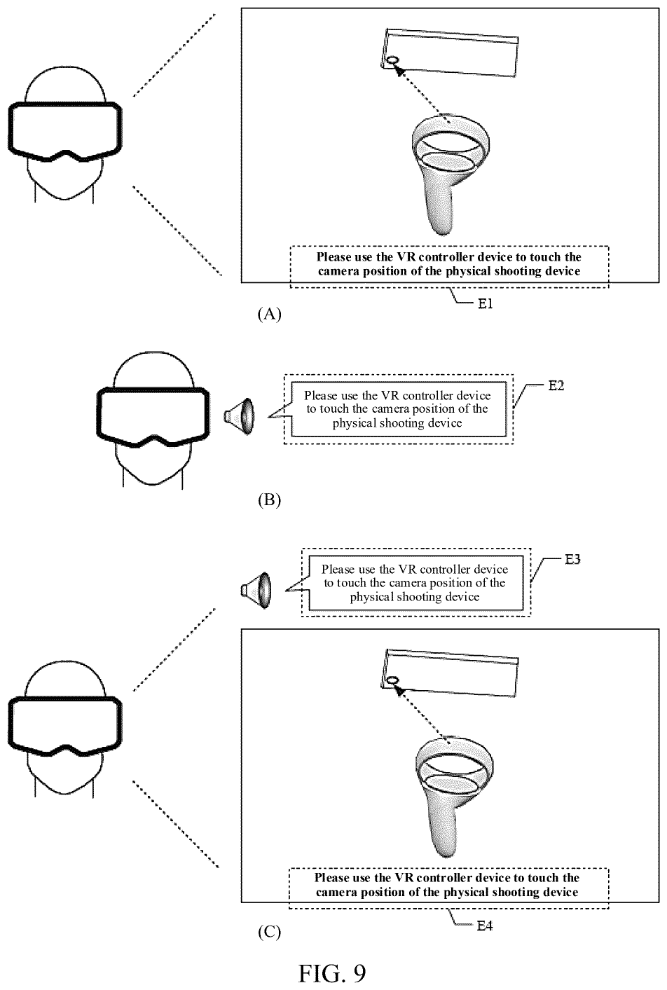

Different prompt manners are respectively described below with reference to FIG. 9 by using an example in which the operation controller is a VR controller device. FIG. 9 is a related schematic diagram of prompting to bring a VR controller device into contact with a camera of a physical shooting device according to an aspect of this disclosure.

### Manner 1: Interface Prompt

During implementation, referring to FIG. 9(A), E1 is configured for indicating a second prompt message. After enabling a see through function, the user can not only see the related prompt through the head-mounted display device, but also see the physical shooting device. Based on this, the second prompt message indicated by E1 can guide the user to bring the VR controller device into contact with the camera of the physical shooting device. When the contact is accurate, the user may trigger the position recording operation for the VR controller device.

### Manner 2: Voice Prompt

During implementation, referring to FIG. 9(B), E2 is configured for indicating a second voice message. After enabling the see through function, the user can not only see the related prompt through the head-mounted display device, but also see the physical shooting device. Based on this, the second voice message indicated by E2 can guide the user to bring the VR controller device into contact with the camera of the physical shooting device. When the contact is accurate, the user may trigger the position recording operation for the VR controller device.

### Manner 3: Combining the Interface Prompt and the Voice Prompt

During implementation, referring to FIG. 9(C), E3 is configured for indicating the second voice message, and E4 is configured for indicating the second prompt message. After enabling the see through function, the user can not only see the related prompt through the head-mounted display device, but also see the physical shooting device. Based on this, the second voice message indicated by E3 and the second prompt message indicated by E4 can guide the user to bring the VR controller device into contact with the camera of the physical shooting device. When the contact is accurate, the user may trigger the position recording operation for the VR controller device.

This aspect of this disclosure provides a manner of prompting the user to perform the position recording operation. In the foregoing manner, a related prompt for recording the camera position of the physical shooting device using the operation controller may be provided to the user through the head-mounted display device. Therefore, the user can be more intuitively guided to perform correct operations, thereby reducing learning costs, and further helping improve the virtual camera calibration effect.

Based on one or more aspects corresponding to FIG. 3, in another aspect provided in this disclosure, before the obtaining the target orientation angle of the operation controller in response to an angle recording operation for the operation controller when the contact plane of the operation controller is attached to the contact plane of the physical shooting device, the method may further include:
displaying a third prompt message through the head-mounted display device, the third prompt message being configured for prompting to attach the contact plane of the operation controller to the contact plane of the physical shooting device;
or
playing a third voice message through the head-mounted display device, the third voice message being configured for prompting to attach the contact plane of the operation controller to the contact plane of the physical shooting device;
or
displaying the third prompt message through the head-mounted display device and playing the third voice message.

In one or more aspects, a manner of prompting the user to perform the angle recording operation is described. It can be known from the foregoing aspects that based on the see through technology, the user can see an augmented reality scene through the head-mounted display device. Therefore, the augmented reality scene can guide the user to perform the related operations. Based on this, before the user triggers the angle recording operation, a related prompt may be provided, to guide the user to attach the operation controller to the physical shooting device.

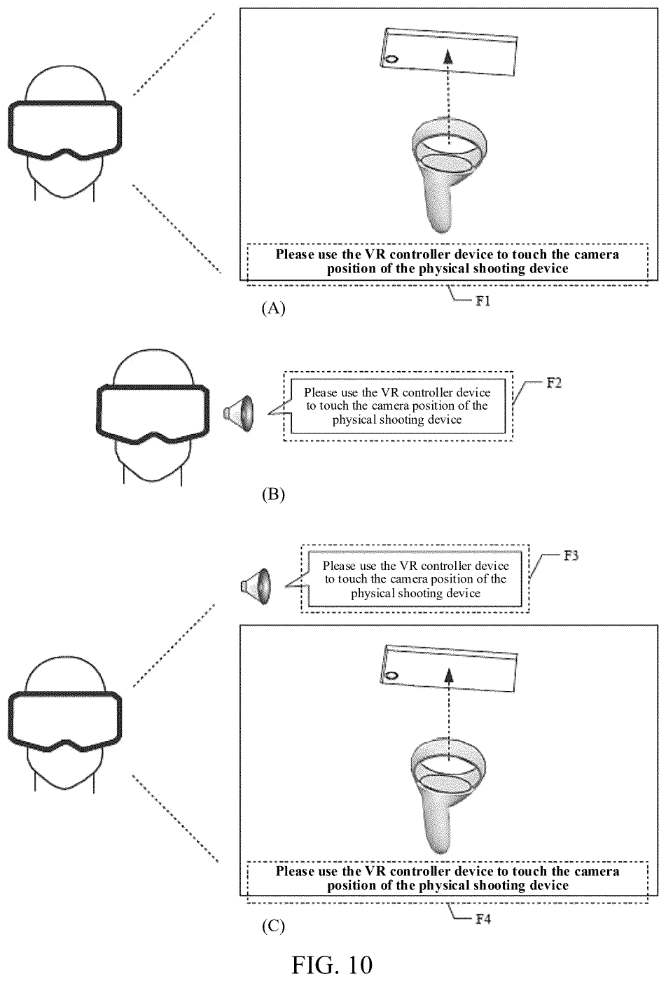

Different prompt manners are respectively described below with reference to FIG. 10 by using an example in which the operation controller is a VR controller device. FIG. 10 is a related schematic diagram of prompting to attach a VR controller device to a physical shooting device according to an aspect of this disclosure.

### Manner 1: Interface Prompt

During implementation, referring to FIG. 10(A), F1 is configured for indicating a third prompt message. After enabling a see through function, the user can not only see the related prompt through the head-mounted display device, but also see the physical shooting device. Based on this, the third prompt message indicated by FI can guide the user to attach the contact plane of the VR controller device to the contact plane of the physical shooting device. When the attachment is accurate, the user may trigger the angle recording operation for the VR controller device.

### Manner 2: Voice Prompt

During implementation, referring to FIG. 10(B), F2 is configured for indicating a third voice message. After enabling the see through function, the user can not only see the related prompt through the head-mounted display device, but also see the physical shooting device. Based on this, the third voice message indicated by F2 can guide the user to attach the contact plane of the VR controller device to the contact plane of the physical shooting device. When the attachment is accurate, the user may trigger the angle recording operation for the VR controller device.

### Manner 3: Combining the Interface Prompt and the Voice Prompt

During implementation, referring to FIG. 10(C), F3 is configured for indicating the third voice message, and F4 is configured for indicating the third prompt message. After enabling the see through function, the user can not only see the related prompt through the head-mounted display device, but also see the physical shooting device. Based on this, the third voice message indicated by F3 and the third prompt message indicated by F4 can guide the user to attach the contact plane of the VR controller device to the contact plane of the physical shooting device. When the attachment is accurate, the user may trigger the angle recording operation for the VR controller device.

This aspect of this disclosure provides a manner of prompting the user to perform the angle recording operation. In the foregoing manner, a related prompt for attaching the operation controller to the physical shooting device may be provided to the user through the head-mounted display device. Therefore, the user can be more intuitively guided to perform correct operations, thereby reducing learning costs, and further helping improve the virtual camera calibration effect.

Based on one or more aspects corresponding to FIG. 3, in another aspect provided in this disclosure, the obtaining, if the target object model corresponding to the physical shooting device is not obtained, the target position information of the operation controller in response to a position recording operation for the operation controller when the operation controller is in contact with the camera of the physical shooting device may include:
displaying, if the target object model corresponding to the physical shooting device is not obtained, a second demonstration animation through the head-mounted display device, the second demonstration animation being configured for guiding a process of calibrating the virtual camera using the operation controller; and
obtaining, in response to a playback end operation for the second demonstration animation, the target position information of the operation controller in response to the position recording operation for the operation controller when the operation controller is in contact with the camera of the physical shooting device.

In one or more aspects, a manner of playing a demonstration animation without using the target object model is described. It can be known from the foregoing aspects that, before calibrating the virtual camera, the user may view the related second demonstration animation through the head-mounted display device or the terminal. Through the second demonstration animation, the user can more intuitively learn how to calibrate the virtual camera. Related content of the second demonstration animation is described below with reference to the drawings.

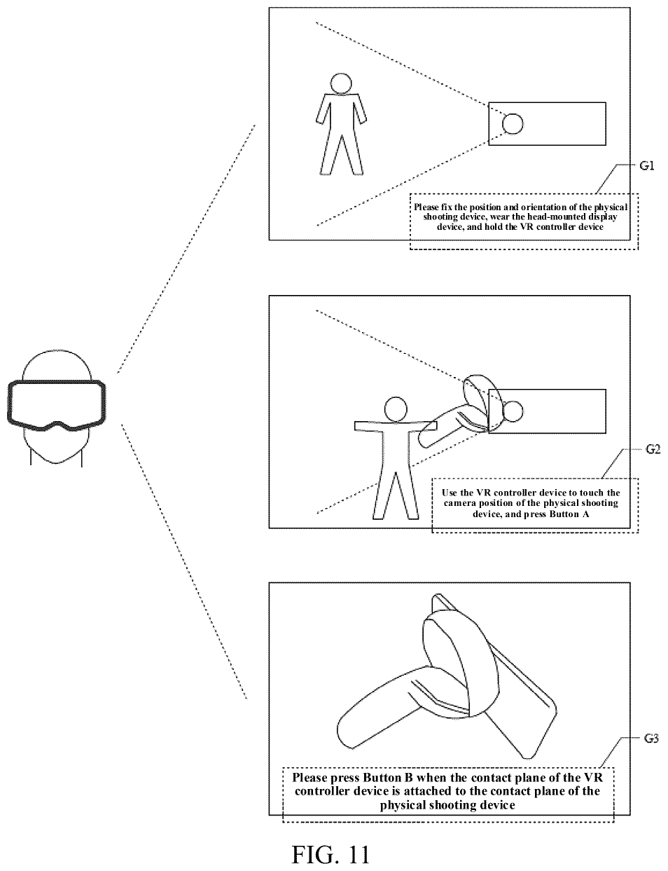

An example in which the operation controller is a VR controller device is used. For ease of understanding, FIG. 11 is a schematic diagram of presenting a second demonstration animation according to an aspect of this disclosure. As shown in FIG. 11, the second demonstration animation prompts, through information indicated by G1, the user to first fix a position and an orientation angle of the physical shooting device, wear the head-mounted display device, and hold the VR controller device, to enter a virtual scene. The prompt content indicated by G1 may be presented in a text form or a voice form. Next, the second demonstration animation prompts, through information indicated by G2, the user to bring the VR controller device into contact with the camera position of the physical shooting device, and press Button A, to trigger the position recording operation. Finally, the second demonstration animation prompts, through information indicated by G3, the user to press Button B of the VR controller device when the contact plane of the VR controller device is attached to the contact plane of the physical shooting device, to trigger the angle recording operation. In this way, automatic calibration of the virtual camera is implemented.

“Button A” and “Button B” of the VR controller device are merely an example. In practical applications, the user may customize other buttons of the VR controller device as “Button A” or “Button B”, which is not limited herein.

In this aspect of this disclosure, a manner of playing a demonstration animation without using the target object model is provided. In the foregoing manner, the demonstration animation is used to guide the user through the process of calibrating the virtual camera. The demonstration animation improves the user's understanding through visual experience, and helps the user understand the calibration process in a simple and easy manner, thereby improving information transmission efficiency.

Based on one or more aspects corresponding to FIG. 3, in another aspect provided in this disclosure, the obtaining the target orientation angle of the operation controller in response to an angle recording operation for the operation controller may include:
obtaining the current orientation angle of the operation controller in response to the angle recording operation for the operation controller; and
determining the target orientation angle of the operation controller based on the current orientation angle and the plane normal vector of the operation controller, the plane normal vector representing a vector perpendicular to the contact plane of the operation controller.

In one or more aspects, a manner of obtaining the target orientation angle based on the angle recording operation is described. It can be known from the foregoing aspects that when the contact plane of the operation controller and the contact plane of the physical shooting device are in the attached state, the user may trigger the angle recording operation for the virtual camera. Based on this, by invoking an “object.getTransform” interface based on the Unity engine, the transformation information of the operation controller in the world coordinate system may be obtained, that is, the target position information and the current orientation angle of the operation controller in the world coordinate system are obtained.

For the manner of calculating the target orientation angle of the operation controller based on the current orientation angle and the plane normal vector of the operation controller, refer to formula (1) to formula (6) of the foregoing aspects, and this is not limited herein.

This aspect of this disclosure provides a manner of obtaining the target orientation angle based on the angle recording operation. In the foregoing manner, the orientation angle of the virtual camera may be calculated based on the current orientation angle and the plane normal vector. No additional calculations are required, and a more accurate calibration effect can be achieved.

Based on one or more aspects corresponding to FIG. 3, in another aspect provided in this disclosure, N pressure sensors are deployed on the contact plane of the operation controller, where N is an integer greater than 1.

Before the displaying, through the head-mounted display device when the contact plane of the operation controller and a contact plane of the physical shooting device are in an attached state, that a camera of the target object model and a camera of the physical shooting
obtaining at least one pressure parameter set through the N pressure sensors, each pressure parameter set including at least one pressure value, and the at least one pressure value being derived from at least one continuously deployed pressure sensor; and
determining a contact state between the contact plane of the operation controller and the contact plane of the physical shooting device based on each pressure parameter set.

In one or more aspects, a manner of detecting a device attached state based on pressure sensors is described. It can be known from the foregoing aspects that the N pressure sensors may be further deployed on the contact plane of the operation controller, and each of the pressure sensors is configured to collect a corresponding pressure value. Pressure balance may be detected based on the pressure values collected by the pressure sensors, so that the attachment between the operation controller and the physical shooting device can be determined.

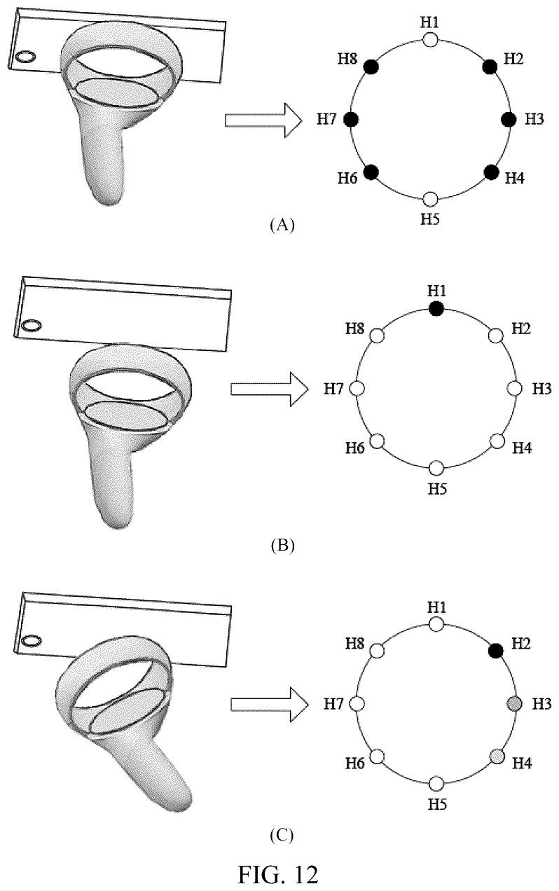

Descriptions are provided below by using an example in which the operation controller is a ring-shaped VR controller device. The ring-shaped VR controller device has a ring, and an infrared light strip is around the ring. The XR device may use an infrared camera to locate a position and an angle of the VR controller in space. For ease of understanding, FIG. 12 is a schematic diagram of detecting a device attached state based on pressure sensors according to an aspect of this disclosure. H1 to H8 respectively represent the pressure sensors deployed on a contact plane of the ring-shaped VR controller device. In this case, N is equal to 8. FIG. 12 shows three different cases, which are respectively analyzed below.

### Case 1

As shown in FIG. 12(A), two pressure parameter sets are currently obtained. Therefore, it may be determined that the ring-shaped VR controller device and the physical shooting device are already in the contact state. A first pressure parameter set includes a pressure value detected by the pressure sensor H2, a pressure value detected by the pressure sensor H3, and a pressure value detected by the pressure sensor H4. A second pressure parameter set includes a pressure value detected by the pressure sensor H6, a pressure value detected by the pressure sensor H7, and a pressure value detected by the pressure sensor H8. Because three points can define a plane, if at least three pressure sensors can detect pressure values, and differences between these pressure values are small, it indicates that the contact plane of the ring-shaped VR controller device and the contact plane of the physical shooting device are in the attached state.

For example, a pressure parameter set is used as an example. Assuming that a difference between a maximum pressure value and a minimum pressure value in the pressure parameter set is less than or equal to a pressure difference threshold, it indicates that the differences between these pressure values are small. In practical applications, the magnitude of the pressure difference may alternatively be determined in another manner. This is not limited herein.

### Case 2

As shown in FIG. 12(B), one pressure parameter set is currently obtained. Therefore, it may be determined that the ring-shaped VR controller device and the physical shooting device are already in the contact state. The pressure parameter set includes a pressure value detected by the pressure sensor H1. Although the ring-shaped VR controller device and the physical shooting device are already in the contact state, because there are less than three pressure sensors that can detect pressure values, it cannot be ensured that the contact plane of the ring-shaped VR controller device and the contact plane of the physical shooting device are in the attached state. Based on this, the user may be prompted to perform a corresponding adjustment.

### Case 3

As shown in FIG. 12(C), one pressure parameter set is currently obtained. Therefore, it may be determined that the ring-shaped VR controller device and the physical shooting device are already in the contact state. The pressure parameter set includes a pressure value detected by the pressure sensor H2, a pressure value detected by the pressure sensor H3, and a pressure value detected by the pressure sensor H4.

It can be known based on the pressure parameter set that although there are at least three pressure sensors that can detect pressure values, differences between these pressure values are large. Therefore, this indicates a pressure imbalance between the ring-shaped VR controller device and the physical shooting device, and the ring-shaped VR controller device may be misaligned or tilted. Based on this, the user may be prompted to perform a corresponding adjustment.

This aspect of this disclosure provides a manner of detecting the device attached state based on the pressure sensors. In the foregoing manner, a force of attachment may be detected by using the pressure sensors deployed on the contact plane of the ring-shaped VR controller device. Therefore, by analyzing the pressure balance, the attachment between the ring-shaped VR controller device and the physical shooting device is determined, so that the user can be prompted to perform an accurate operation, thereby improving calibration accuracy of the virtual camera.

Based on one or more aspects corresponding to FIG. 3, in another aspect provided in this disclosure, the method may further include:
enabling a see through function of the head-mounted display device in response to a function enabling operation for the head-mounted display device;
the displaying, through a head-mounted display device, the target object model linked with an operation controller may include:
displaying, through the head-mounted display device based on the see through function of the head-mounted display device, the target object model linked with the operation controller; and
the displaying, through the head-mounted display device, that a camera of the target object model and a camera of the physical shooting device are in an overlapping state may include:
displaying, through the head-mounted display device based on the see through function of the head-mounted display device, that the camera of the target object model and the camera of the physical shooting device are in the overlapping state.

In one or more aspects, a manner of enabling the see through function is described. It can be known from the foregoing aspects that, after wearing the head-mounted display device, if the user needs to see an object (for example, a physical shooting device) in the real-world scene, the user further needs to enable the see through function.

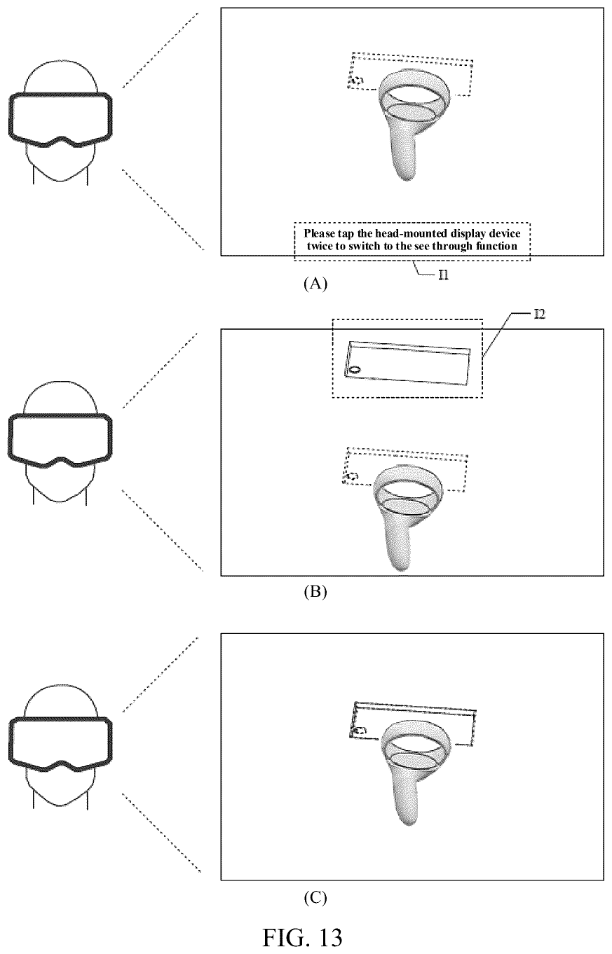

For ease of understanding, an example in which the operation controller is a VR controller device is used. FIG. 13 is a schematic diagram of enabling a see through function according to an aspect of this disclosure. As shown in FIG. 13(A), the user may view a prompt indicated by Il in a virtual scene, for example, “Please tap the head-mounted display device twice to switch to the see through function”. Based on this, when the user taps the head-mounted display device twice, a function enabling operation for the head-mounted display device is triggered, thereby enabling the see through function of the head-mounted display device. In practical applications, the function enabling operation may alternatively be triggered in another manner, such as a voice input or a gesture input.

As shown in FIG. 13(B), after enabling the see through function, the user can see, through the head-mounted display device, the physical shooting device indicated by 12. Therefore, the user may attach the VR controller device to the physical shooting device.

As shown in FIG. 13(C), after enabling the see through function, if the user accurately attaches the contact plane of the VR controller device to the contact plane of the physical shooting device, the user can see, through the head-mounted display device, that the camera of the target object model and the camera of the physical shooting device are in the overlapping state.

This aspect of this disclosure provides a manner of enabling the see through function. In the foregoing manner, based on the see through function, it allows the user to interact with the external real world without removing the head-mounted display device, thereby improving sustainability of the XR device experience. In addition, integrating AR functions into the see through function allows the user to experience more AR functions, thereby implementing interaction between the real world and the virtual world.

Based on one or more aspects corresponding to FIG. 3, in another aspect provided in this disclosure, the method may further include:
displaying a calibration prompt message, the calibration prompt message being configured for presenting whether to calibrate the virtual camera;
performing, if responding to a confirmation operation for the calibration prompt message, the operation of displaying, through a head-mounted display device when obtaining a target object model corresponding to a physical shooting device, the target object model linked with an operation controller; or
calibrating the virtual camera based on historical spatial information of the operation controller if responding to a cancellation operation for the calibration prompt message, the historical spatial information including previously obtained spatial information of the operation controller.

In one or more aspects, a manner of triggering a virtual camera calibration process is described. It can be known from the foregoing aspects that, if the physical shooting device configured to perform MRC are fixed at the same position, the user may skip the virtual camera calibration process when restarting the XR device. Based on this, the user may select, through the terminal or the XR device, whether to skip the virtual camera calibration process.

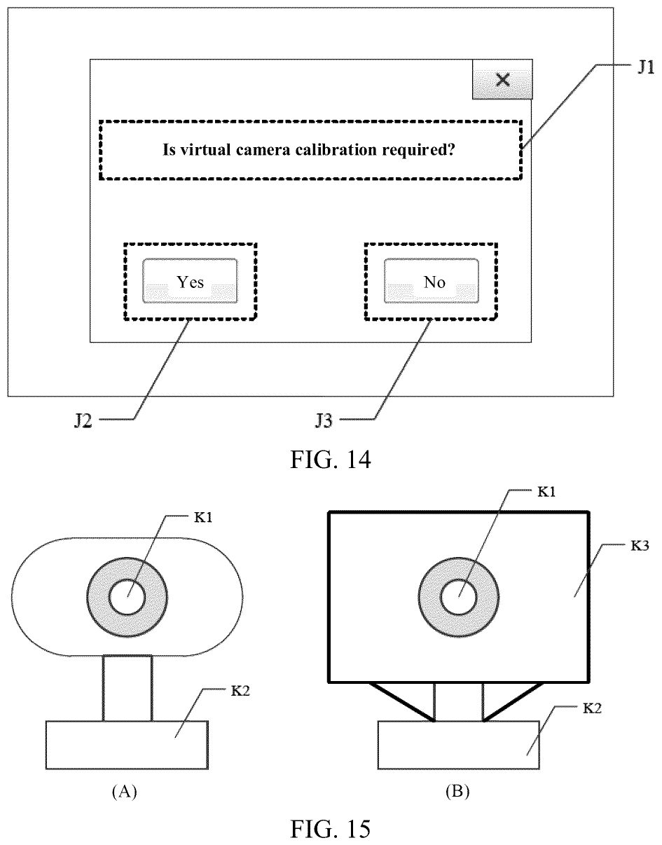

For ease of understanding, FIG. 14 is a schematic diagram of displaying a calibration prompt message according to an aspect of this disclosure. As shown in FIG. 14, J1 is configured for indicating the calibration prompt message, and is configured for prompting the user whether to calibrate the virtual camera. If the user taps a confirmation control indicated by J2, the confirmation operation for the calibration prompt message is triggered, thereby continuing the virtual camera calibration process. If the user taps a cancellation control indicated by J3, the cancellation operation for the calibration prompt message is triggered, thereby calibrating the virtual camera based on the historical spatial information of the operation controller. The historical spatial information includes previously obtained spatial information of the operation controller.

This aspect of this disclosure provides a manner of triggering the virtual camera calibration process. In the foregoing manner, when the position of the physical shooting device remains fixed, the user may skip the operation of calibrating the virtual camera. Therefore, flexibility of the solution can be improved, and operation time can be saved.

Based on one or more aspects corresponding to FIG. 3, in another aspect provided in this disclosure, the physical shooting device is a camera device, the camera device including a camera and a camera base.

The camera is fixed to the camera base.

The camera base is provided with a detachable panel, the detachable panel being provided with a hollowed-out area, the hollowed-out area being configured for the camera to pass through.

The method may further include:
determining, when the contact plane of the operation controller is attached to the detachable panel, that the contact plane of the operation controller and the contact plane of the physical shooting device are in the attached state.

In one or more aspects, a manner of performing assistant attachment using the detachable panel is provided. It can be known from the foregoing aspects that when resolution of a terminal (such as a mobile phone or a tablet computer) is low, the user may alternatively select the camera device as the physical shooting device. That is, the camera device establishes a communication connection with the terminal, and transmits a captured video stream to the terminal for subsequent processing.

For ease of understanding, FIG. 15 is a schematic comparison diagram of performing assisted attachment on a camera device according to an aspect of this disclosure. As shown in FIG. 15(A), K1 is configured for indicating the camera, and K2 is configured for indicating the camera base. The camera is fixed to the camera base. Because the contact plane of the camera device may be not flat, the detachable panel may be used to assist in attaching the operation controller to the camera device.

As shown in FIG. 15(B), K3 is configured for indicating the detachable panel. The detachable panel indicated by K3 is provided with a hollowed-out area, and the camera indicated by KI can pass through the hollowed-out area, thereby preventing the detachable panel from blocking a field of view of the camera. The detachable panel indicated by K3 may be fixed to the camera base indicated by K2. Based on this, the user may attach the contact plane of the operation controller to the detachable panel, thereby implementing the attachment between the contact plane of the operation controller and the contact plane of the physical shooting device.

This aspect of this disclosure provides a manner of performing assistant attachment using the detachable panel. In the foregoing manner, considering that the contact plane of the camera device may be not flat, the detachable panel can provide a flat contact plane for the camera device, making it convenient for the user to attach the operation controller to the camera device.

Based on one or more aspects corresponding to FIG. 3, in another aspect provided in this disclosure, a calibrated virtual camera includes a virtual foreground camera and a virtual background camera.

The method may further include:
rendering a foreground space of a virtual scene by using the virtual foreground camera, to obtain a virtual foreground image;
rendering a background space of the virtual scene by using virtual background camera, to obtain a virtual background image, the virtual foreground image and the virtual background image corresponding to the same timestamp; and
sending the virtual foreground image and the virtual background image to the physical shooting device, to enable the physical shooting device to generate and display a composite recorded image for the timestamp based on the virtual foreground image, the virtual background image, and a matted image, the matted image being generated after matting a real-world scene image, and the real-world scene image being captured by the camera of the physical shooting device.

In one or more aspects, a manner of implementing MRC is described. It can be known from the foregoing aspects that, after completing calibration of the virtual camera, the user may enable the MRC function for video recording. To achieve video synchronization, the virtual foreground image, the virtual background image, and the matted image that correspond to the same timestamp need to be composited, to obtain a frame of composite recorded image. Finally, the composite recorded images corresponding to timestamps are sequentially outputted, to obtain a composite video stream.

The following describes a process of generating the composite recorded image by using one timestamp as an example. In addition, it is assumed that the physical shooting device is a mobile phone.

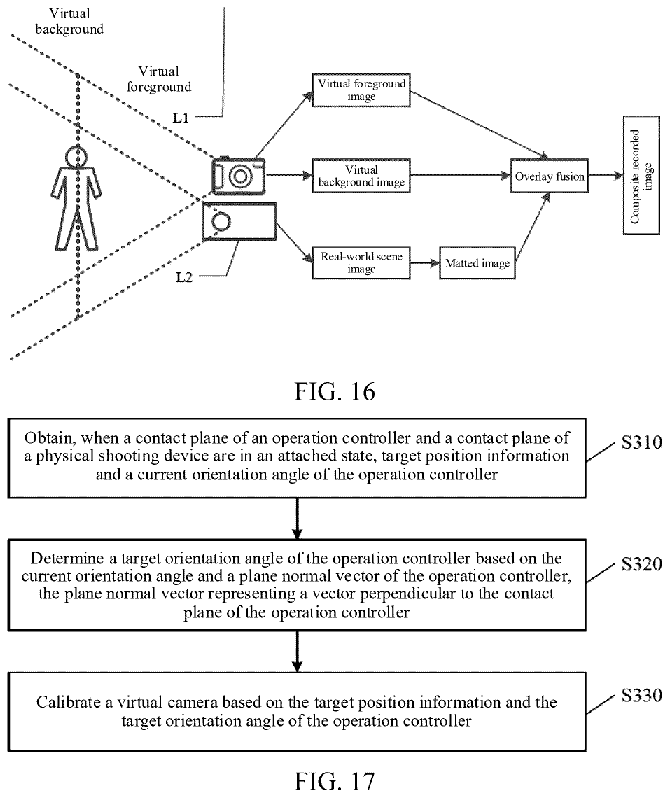

For ease of understanding, FIG. 16 is a schematic diagram of implementing mixed reality capture according to an aspect of this disclosure. As shown in FIG. 16, LI is configured for indicating a virtual camera. The virtual camera includes a virtual foreground camera and a virtual background camera. The virtual foreground camera and the virtual background camera have the same position information and orientation angles. The virtual foreground camera is configured to render the foreground, and the virtual background camera is configured to render the background. The foreground refers to scene space from the virtual camera to the user, and the background refers to scene space from the user to infinity. L2 is configured for indicating the physical shooting device.

Based on this, using one timestamp as an example, the virtual foreground camera is used to render the foreground space of the virtual scene, to obtain a virtual foreground image corresponding to the timestamp. Similarly, the virtual background camera is used to render the background space of the virtual scene, to obtain a virtual background image corresponding to the timestamp. Therefore, the virtual foreground image and the virtual background image are transmitted to the physical shooting device by using a wireless screen mirroring technology.

At the same time, the physical shooting device also records a scene including the user, thereby obtaining a real-world scene image corresponding to the timestamp. Therefore, the physical shooting device invokes the deep learning-based matting model to perform portrait matting on the real-world scene image, to obtain the matted image. Finally, the physical shooting device overlays the images on a frame of image in a sequence of first placing the virtual background image, then placing the matted image, and finally placing the virtual foreground image, to obtain a frame of composite recorded image.

This aspect of this disclosure provides a manner of implementing MRC. In the foregoing manner, the calibration of the virtual camera is can achieve a more accurate calibration result, thereby obtaining a video stream with a better composite effect after MRC. Therefore, it helps improve user experience.

With reference to the foregoing descriptions, the virtual camera calibration method in this disclosure is described below. Referring to FIG. 17, the virtual camera calibration method in the aspects of this disclosure may be performed independently by an XR device, may be performed cooperatively by an XR device and a terminal, or may be performed cooperatively by an XR device, a terminal, and a server. The method in this disclosure includes the following operations.

310: Obtain, when a contact plane of an operation controller and a contact plane of a physical shooting device are in an attached state, target position information and a current orientation angle of the operation controller.

In one or more aspects, the user may attach the operation controller to the physical shooting device. In other words, when the contact plane of the operation controller and the contact plane of the physical shooting device are in the attached state, transformation information of the operation controller in a world coordinate system can be directly obtained by using a related method in an XR development platform SDK. The transformation information includes target position information and a current orientation angle.

320: Determine a target orientation angle of the operation controller based on the current orientation angle and a plane normal vector of the operation controller, the plane normal vector representing a vector perpendicular to the contact plane of the operation controller.

In one or more aspects, the target orientation angle of the operation controller may be calculated based on the current orientation angle and the plane normal vector of the operation controller. The plane normal vector is a vector perpendicular to the contact plane of the operation controller, and the plane normal vector forms a fixed angle with an initial orientation angle of the operation controller. The target orientation angle of the operation controller in the world coordinate system is an orientation angle of a camera of the physical shooting device in the world coordinate system.

For the manner of calculating the target orientation angle of the operation controller based on the current orientation angle and the plane normal vector of the operation controller, refer to formula (1) to formula (6) of the foregoing aspects, and this is not limited herein.

330: Calibrate a virtual camera based on the target position information and the target orientation angle of the operation controller.

In one or more aspects, if a target object model is used, when a camera of the target object model overlaps with the camera of the physical shooting device, offset calculation is performed on the target position information of the operation controller in the world coordinate system based on a position offset between a camera position of the target object model and the operation controller, to obtain position information of the camera of the target object model in the world coordinate system. The position information of the camera of the target object model in the world coordinate system is position information of the camera of the physical shooting device in the world coordinate system.

If the target object model is not used, when the operation controller touches the camera of the physical shooting device, the position information of the camera of the physical shooting device in the world coordinate system can be directly obtained.

When position calibration is performed on the virtual camera, position information of the virtual camera in the world coordinate system needs to be aligned with the position information of the camera of the physical shooting device in the world coordinate system. Therefore, the position calibration of the virtual camera can be completed by using the position information of the camera of the physical shooting device in the world coordinate system as the position information of the virtual camera in the world coordinate system.

When the position calibration is performed on the virtual camera, an orientation angle of the virtual camera in the world coordinate system needs to be aligned with the orientation angle of the camera of the physical shooting device in the world coordinate system. Therefore, the target orientation angle of the operation controller in the world coordinate system is used as the orientation angle of the virtual camera in the world coordinate system, to complete orientation angle calibration of the virtual camera.

This aspect of this disclosure provides a virtual camera calibration method. In the foregoing manner, calibration of the virtual camera may be implemented based on the position information and the orientation angle of the operation controller. This eliminates the need for additional calculations during virtual camera calibration while achieving higher accuracy, thereby improving calibration efficiency of the virtual camera.

Based on one or more aspects corresponding to FIG. 17, in another aspect

provided in this disclosure, the obtaining, when a contact plane of an operation controller and a contact plane of a physical shooting device are in an attached state target position information and a current orientation angle of the operation controller may include:
displaying, through a head-mounted display device when obtaining a target object model corresponding to the physical shooting device and when the contact plane of the operation controller and the contact plane of the physical shooting device are in the attached state, that a camera of the target object model and a camera of the physical shooting device are in an overlapping state, the contact plane of the target object model and the contact plane of the operation controller being in the attached state, and a camera position of the target object model having a correspondence with a camera position of the physical shooting device; and
obtaining the target position information and the current orientation angle of the operation controller in response to the spatial calibration operation for the virtual camera.

In one or more aspects, a manner of calibrating the virtual camera using the target object model is described. It can be known from the foregoing aspects that when the contact plane of the operation controller and the contact plane of the physical shooting device are in the attached state, and the camera of the target object model and the camera of the physical shooting device are in the overlapping state, the user may trigger a spatial calibration operation for the virtual camera. Based on this, by invoking an “object.getTransform” interface based on the Unity engine, the transformation information of the operation controller in the world coordinate system may be obtained, that is, the target position information and the current orientation angle of the operation controller in the world coordinate system are obtained.

This aspect of this disclosure provides a manner of calibrating the virtual camera using the target object model. In the foregoing manner, the position information of the virtual camera can be directly determined by using the known target position information and the camera position of the target object model. There is no need for the user to touch the camera of the physical shooting device using the operation controller, thereby improving calibration efficiency. In addition, the orientation angle of the virtual camera can be calculated by using the known current orientation angle and the plane normal vector. It can be seen that the operations of calibrating the virtual camera are relatively simple, requiring no additional calculations, and a more accurate calibration effect can be achieved.

Based on one or more aspects corresponding to FIG. 17, in another aspect provided in this disclosure, the obtaining, when a contact plane of an operation controller and a contact plane of a physical shooting device are in an attached state, target position information and a current orientation angle of the operation controller may include:
obtaining, if the target object model corresponding to the physical shooting device is not obtained, the target position information of the operation controller in response to a position recording operation for the operation controller when the operation controller is in contact with the camera of the physical shooting device; and
obtaining the current orientation angle of the operation controller in response to an angle recording operation for the operation controller when the contact plane of the operation controller is attached to the contact plane of the physical shooting device.

In one or more aspects, a manner of calibrating the virtual camera without using the target object model is described. It can be known from the foregoing aspects that, the user may bring the operation controller into contact with the camera of the physical shooting device, and trigger a position recording operation for the operation controller when the operation controller comes into contact with the camera of the physical shooting device, to obtain the target position information of the operation controller. The user further needs to attach the contact plane of the operation controller to the contact plane of the physical shooting device, and trigger an angle recording operation for the operation controller when the contact plane of the physical shooting device is attached to the contact plane of the physical shooting device, to obtain the current orientation angle of the operation controller.

This aspect of this disclosure provides a manner of calibrating the virtual camera without using the target object model. In the foregoing manner, if the target object model matching the physical shooting device cannot be obtained, the operation controller may be used to touch the camera of the physical shooting device, to locate the camera position of the physical shooting device. In this way, the flexibility and operability of the solution are improved.

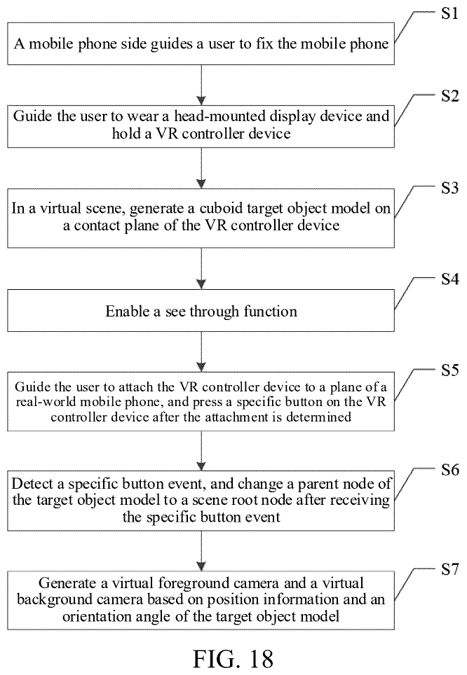

With reference to the foregoing aspects, the following describes a virtual camera calibration process by using a specific scenario as an example. In this scenario, the operation controller is a VR controller device. For ease of understanding, FIG. 18 is an overall schematic flowchart of virtual camera calibration according to an aspect of this disclosure. As shown in FIG. 18, for example, the following operations are included.

Operation S1: Using a mobile phone as an example of the physical shooting device, the mobile phone guides the user to fix the mobile phone.

Operation S2: The mobile phone further guides the user to wear the head-mounted display device and hold the VR controller device.

Operation S3: The user can see a virtual scene through the head-mounted display device. In the virtual scene, a cuboid object is generated on a contact plane of the VR controller device, the cuboid object being the target object model. The target object model is attached to the contact plane of the VR controller device.

Operation S4: The user enables a see through function.

Operation S5: The mobile phone or the head-mounted display device guides the user to attach the VR controller device to a plane of the mobile phone, and press a specific button on the VR controller device after the attachment is determined.

Operation S6: The VR controller device continuously detects a specific button event. After the specific button event is received, a parent node corresponding to the target object model is used as a scene root node.

Operation S7: Based on this, generate a virtual camera based on position information and an orientation angle of the target object model, where the virtual camera includes a virtual foreground camera and a virtual background camera.

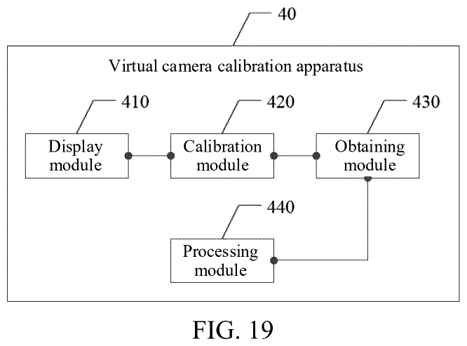

A virtual camera calibration apparatus in this disclosure is described below in further detail. FIG. 19 is a schematic diagram of a virtual camera calibration apparatus according to an aspect of this disclosure. The virtual camera calibration apparatus 40 includes:
a display module 410, configured to: display, through a head-mounted display device when a target object model corresponding to a physical shooting device is obtained, the target object model linked with an operation controller, a contact plane of the target object model and a contact plane of the operation controller being in an attached state, and a camera position of the target object model having a correspondence with a camera position of the physical shooting device,
the display module 410 being further configured to: display, through the head-mounted display device when the contact plane of the operation controller and a contact plane of the physical shooting device are in an attached state, that a camera of the target object model and a camera of the physical shooting device are in an overlapping state; and
a calibration module 420, configured to calibrate the virtual camera based on spatial information of the operation controller in response to a spatial calibration operation for the virtual camera, the spatial information including target position information and a target orientation angle.

In some aspects, based on the aspect corresponding to FIG. 19, in another aspect of the virtual camera calibration apparatus 40 provided in the aspects of this disclosure, the virtual camera calibration apparatus 40 further includes an obtaining module 430.

The obtaining module 430 is configured to: before the target object model linked with the operation controller is displayed through the head-mounted display device when the target object model corresponding to the physical shooting device is obtained, obtain the target object model corresponding to the physical shooting device from a locally stored model resource set in response to a model invocation request, the model invocation request carrying model information of the physical shooting device, the model resource set including at least one object model, each object model corresponding to one piece of model information, and the target object model corresponding to the model information carried in the model invocation request.

In some aspects, based on the aspect corresponding to FIG. 19, in another aspect of the virtual camera calibration apparatus 40 provided in the aspects of this disclosure, the virtual camera calibration apparatus further includes a processing module 440.

The processing module 440 is configured to, before the target object model linked with the operation controller is displayed through the head-mounted display device when the target object model corresponding to the physical shooting device is obtained, send a model download request to a server in response to a model invocation request, the model invocation request carrying model information of the physical shooting device, and the model download request carrying the model information of the physical shooting device; and
the processing module 440 is further configured to receive the target object model corresponding to the physical shooting device that is sent by the server, the target object model corresponding to the model information carried in the model download request.

In some aspects, based on the aspect corresponding to FIG. 19, in another aspect of the virtual camera calibration apparatus 40 provided in the aspects of this disclosure,
the display module 410 is further configured to: after the target object model linked with the operation controller is displayed through the head-mounted display device when the target object model corresponding to the physical shooting device is obtained, display a first prompt message through the head-mounted display device, the first prompt message being configured for prompting to attach the contact plane of the operation controller to the contact plane of the physical shooting device, and align the target object model with the physical shooting device;
or
the display module 410 is further configured to play a first voice message through the head-mounted display device, the first voice message being configured for prompting to attach the contact plane of the operation controller to the contact plane of the physical shooting device and align the target object model with the physical shooting device;
or
the display module 410 is further configured to display the first prompt message through the head-mounted display device and play the first voice message.

Based on the aspect corresponding to FIG. 19, in another aspect of the virtual camera calibration apparatus 40 provided in the aspects of this disclosure,
the display module 410 is further configured to display a first demonstration animation through the head-mounted display device, the first demonstration animation being configured for guiding a process of calibrating the virtual camera using the operation controller.

Based on the aspect corresponding to FIG. 19, in another aspect of the virtual camera calibration apparatus 40 provided in the aspects of this disclosure,
the calibration module 420 is configured to obtain target position information and a current orientation angle of the operation controller in response to the spatial calibration operation for the virtual camera;
determine position information of the virtual camera based on the target position information and a camera position of the target object model;
determine the target orientation angle of the operation controller based on the current orientation angle and the plane normal vector of the operation controller, the plane normal vector representing a vector perpendicular to the contact plane of the operation controller; and
calibrate the virtual camera using the position information of the virtual camera and the target orientation angle.

Based on the aspect corresponding to FIG. 19, in another aspect of the virtual camera calibration apparatus 40 provided in the aspects of this disclosure,
the obtaining module 430 is further configured to obtain, if the target object model corresponding to the physical shooting device is not obtained, the target position information of the operation controller in response to a position recording operation for the operation controller when the operation controller is in contact with the camera of the physical shooting device;
the obtaining module 430 is further configured to obtain the target orientation angle of the operation controller in response to an angle recording operation for the operation controller when the contact plane of the operation controller is attached to the contact plane of the physical shooting device; and
the calibration module 420 is further configured to calibrate the virtual camera based on the target position information and the target orientation angle.

Based on the aspect corresponding to FIG. 19, in another aspect of the virtual camera calibration apparatus 40 provided in the aspects of this disclosure,
the display module 410 is further configured to, before the target position information of the operation controller is obtained in response to the position recording operation for the operation controller when the operation controller is in contact with the camera of the physical shooting device, display a second prompt message through the head-mounted display device, the second prompt message being configured for prompting to bring the operation controller into contact with the camera of the physical shooting device;
or
the display module 410 is further configured to play a second voice message through the head-mounted display device, the second voice message being configured for prompting to bring the operation controller into contact with the camera of the physical shooting device;
or
the display module 410 is further configured to display the second prompt message through the head-mounted display device and play the second voice message.

Based on the aspect corresponding to FIG. 19, in another aspect of the virtual camera calibration apparatus 40 provided in the aspects of this disclosure,
the display module 410 is further configured to: before the target orientation angle of the operation controller is obtained in response to the angle recording operation for the operation controller when the contact plane of the operation controller is attached to the contact plane of the physical shooting device, display a third prompt message through the head-mounted display device, the third prompt message being configured for prompting to attach the contact plane of the operation controller to the contact plane of the physical shooting device;
or
the display module 410 is further configured to play a third voice message through the head-mounted display device, the third voice message being configured for prompting to attach the contact plane of the operation controller to the contact plane of the physical shooting device;
or
the display module 410 is further configured to display the third prompt message through the head-mounted display device and play the third voice message.

Based on the aspect corresponding to FIG. 19, in another aspect of the virtual camera calibration apparatus 40 provided in the aspects of this disclosure,
the obtaining module 430 is configured to display, if the target object model corresponding to the physical shooting device is not obtained, a second demonstration animation through the head-mounted display device, the second demonstration animation being configured for guiding a process of calibrating the virtual camera using the operation controller; and
obtain, in response to a playback end operation for the second demonstration animation, the target position information of the operation controller in response to the position recording operation for the operation controller when the operation controller is in contact with the camera of the physical shooting device.

Based on the aspect corresponding to FIG. 19, in another aspect of the virtual camera calibration apparatus 40 provided in the aspects of this disclosure,
the obtaining module 430 is configured to obtain the current orientation angle of the operation controller in response to the angle recording operation for the operation controller; and
determine the target orientation angle of the operation controller based on the current orientation angle and a plane normal vector of the operation controller, the plane normal vector representing a vector perpendicular to the contact plane of the operation controller.

Based on one or more aspects corresponding to FIG. 19, in another aspect of the virtual camera calibration apparatus 40 provided in the aspects of this disclosure, N pressure sensors are deployed on the contact plane of the operation controller, N being an integer greater than 1.

The obtaining module 430 is further configured to: before that the camera of the target object model and the camera of the physical shooting device are in the overlapping state is displayed through the head-mounted display device when the contact plane of the operation controller and a contact plane of the physical shooting device are in the attached state, obtain at least one pressure parameter set through the N pressure sensors, each pressure parameter set including at least one pressure value, and the at least one pressure value being derived from at least one continuously deployed pressure sensor; and
the processing module 440 is further configured to determine a contact state between the contact plane of the operation controller and the contact plane of the physical shooting device based on each pressure parameter set.

Based on the aspect corresponding to FIG. 19, in another aspect of the virtual camera calibration apparatus 40 provided in the aspects of this disclosure,
the processing module 440 is further configured to enable a see through function of the head-mounted display device in response to a function enabling operation for the head-mounted display device; and
the display module 410 is configured to display, through the head-mounted display device based on the see through function of the head-mounted display device, the target object model linked with the operation controller.

Based on the aspect corresponding to FIG. 19, in another aspect of the virtual camera calibration apparatus 40 provided in the aspects of this disclosure,
the display module 410 is configured to display, through the head-mounted display device based on the see through function of the head-mounted display device, that the camera of the target object model and the camera of the physical shooting device are in the overlapping state.

Based on the aspect corresponding to FIG. 19, in another aspect of the virtual camera calibration apparatus 40 provided in the aspects of this disclosure,
the display module 410 is further configured to display a calibration prompt message, the calibration prompt message being configured for presenting whether to calibrate the virtual camera;
the processing module 440 is further configured to perform, if responding to a confirmation operation for the calibration prompt message, the operation of displaying, through a head-mounted display device when a target object model corresponding to a physical shooting device is obtained, the target object model linked with an operation controller; and
the calibration module 420 is further configured to calibrate the virtual camera based on historical spatial information of the operation controller if responding to a cancellation operation for the calibration prompt message, the historical spatial information including previously obtained spatial information of the operation controller.

Based on the aspect corresponding to FIG. 19, in another aspect of the virtual camera calibration apparatus 40 provided in the aspects of this disclosure, the physical shooting device is a camera device, the camera device including a camera and a camera base.

The camera is fixed to the camera base.

The camera base is provided with a detachable panel, the detachable panel being provided with a hollowed-out area, the hollowed-out area being configured for the camera to pass through.

The processing module 440 is further configured to determine, when the contact plane of the operation controller is attached to the detachable panel, that the contact plane of the operation controller and the contact plane of the physical shooting device are in the attached state.

In some aspects, based on the aspect corresponding to FIG. 19, in another aspect of the virtual camera calibration apparatus 40 provided in the aspects of this disclosure, a calibrated virtual camera includes a virtual foreground camera and a virtual background camera.

The processing module 440 is further configured to render a foreground space of a virtual scene by using the virtual foreground camera, to obtain a virtual foreground image;
the processing module 440 is further configured to render a background space of the virtual scene by using the virtual background camera, to obtain a virtual background image, the virtual foreground image and the virtual background image corresponding to the same timestamp; and
the processing module 440 is further configured to send the virtual foreground image and the virtual background image to the physical shooting device, to enable the physical shooting device to generate and display a composite recorded image for the timestamp based on the virtual foreground image, the virtual background image, and a matted image, the matted image being generated after matting a real-world scene image, and the real-world scene image being captured by the camera of the physical shooting device.

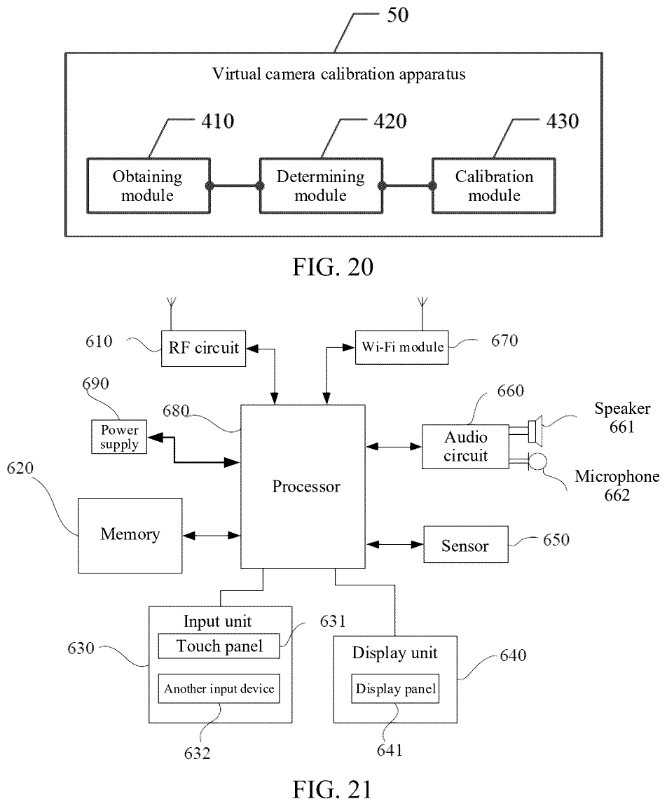

A virtual camera calibration apparatus in this disclosure is described below in further detail. FIG. 20 is another schematic diagram of a virtual camera calibration apparatus according to an aspect of this disclosure. The virtual camera calibration apparatus 50 includes:
an obtaining module 510, configured to obtain, when a contact plane of an operation controller and a contact plane of a physical shooting device are in an attached state, target position information and a current orientation angle of the operation controller;
a determining module 520, configured to determine a target orientation angle of the operation controller based on the current orientation angle and a plane normal vector of the operation controller, the plane normal vector representing a vector perpendicular to the contact plane of the operation controller; and
a calibration module 530, configured to calibrate a virtual camera based on the target position information and the target orientation angle of the operation controller.

Based on the aspect corresponding to FIG. 20, in another aspect of the virtual camera calibration apparatus 50 provided in the aspects of this disclosure,
the obtaining module 510 is configured to: display, through a head-mounted display device when the target object model corresponding to the physical shooting device is obtained and when the contact plane of the operation controller and the contact plane of the physical shooting device are in the attached state, that a camera of the target object model and a camera of the physical shooting device are in an overlapping state, the contact plane of the target object model and the contact plane of the operation controller being in the attached state, and a camera position of the target object model having a correspondence with a camera position of the physical shooting device; and
obtain the target position information and the current orientation angle of the operation controller in response to a spatial calibration operation for the virtual camera.

Based on the aspect corresponding to FIG. 20, in another aspect of the virtual camera calibration apparatus 50 provided in the aspects of this disclosure,
the obtaining module 510 is configured to obtain, if the target object model corresponding to the physical shooting device is not obtained, the target position information of the operation controller in response to a position recording operation for the operation controller when the operation controller is in contact with the camera of the physical shooting device; and
obtain the current orientation angle of the operation controller in response to an angle recording operation for the operation controller when the contact plane of the operation controller is attached to the contact plane of the physical shooting device.

An aspect of this disclosure further provides a terminal, as shown in FIG. 21. For ease of description, only parts related to the aspects of this disclosure are shown. For examples of technical details that are not disclosed, reference can be made to the method part of the aspects of this disclosure. In this aspect of this disclosure, an example in which the terminal is an XR device is used for description.

FIG. 21 is a block diagram of a part of a structure of an XR device related to the terminal provided in this aspect of this disclosure. Referring to FIG. 21, the XR device includes components such as a radio frequency (RF) circuit 610, a memory 620 (for example, a non-transitory computer-readable storage medium), an input unit 630, a display unit 640, a sensor 650, an audio circuit 660, a mobile hotspot (for example, Wi-Fi) module 670, a processor 680 (for example, processing circuitry), and a power supply 690. The input unit 630 may include a touch panel 631 and another input device 632. The display unit 640 may include a display panel 641. The audio circuit 660, a speaker 661, and a microphone 662 may provide an audio interface between a user and the XR device. It is noted that the structure of the XR device shown in FIG. 21 does not constitute a limitation to the XR device, and the XR device may include more or fewer components than those shown in FIG. 21, or some components may be combined, or a different component deployment may be used.

Although not shown in the figure, the XR device may further include a camera, a Bluetooth module, and the like, which are not described in detail herein.

Steps performed by the terminal in the foregoing aspects may be based on the structure of the terminal that is shown in FIG. 21.

An aspect of this disclosure further provides a computer-readable storage medium, such as a non-transitory computer-readable storage medium, having a computer program stored therein. The computer program, when executed by a processor, implements the steps of the methods described in the foregoing aspects.

An aspect of this disclosure further provides a computer program product, including a computer program. The computer program, when executed by a processor, implements the steps of the methods described in the foregoing aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that, for the purpose of convenient and brief description, for a detailed working process of the foregoing system, apparatus, and unit, reference can be made to a corresponding process in the foregoing method aspects, and details are not described herein again.

In the several aspects provided in this disclosure, the disclosed system, apparatus, and method may be implemented in other manners. For example, the described apparatus aspects are only examples. For example, the division of the units is only a logical function division and may be other divisions during actual implementation. For example, a plurality of units or components may be combined or integrated into another system, or some features may be ignored or not performed. In addition, the shown or discussed mutual coupling or direct coupling or communication connection may be indirect coupling or communication connection by using some interfaces, apparatuses, or units, which may be in electrical, mechanical, or another form.

The units described as separate parts may or may not be physically separate. Parts displayed as units may or may not be physical units, and may be located in one position, or may be distributed on a plurality of network units. Some or all of the units may be selected based on actual needs, to achieve the objective of the solution of the aspects.

In addition, the functional units in the aspects of this disclosure may be integrated into one processing unit, or each of the units may independently exist physically, or two or more units may be integrated into one unit. The integrated unit may be implemented in a form of hardware or a software function unit.

If the integrated unit is implemented in the form of the software functional unit and is sold or used as an independent product, the integrated unit may be stored in a computer-readable storage medium, such as a non-transitory computer-readable storage medium. Based on such understanding, the technical solutions of this disclosure may be implemented in a form of a software product. The computer software product is stored in a storage medium, and includes several instructions for enabling a computer device (which may be a server, a terminal device, or the like) to perform all or some operations of the method based on each of the aspects of this disclosure. The foregoing storage medium includes any medium that can store a computer program, such as a USB flash drive, a removable hard disk, a read-only memory (ROM), and a random access memory (RAM), a magnetic disk, or an optical disc.

Based on the above, the foregoing aspects are merely intended to describe the technical solutions of this disclosure, and are not intended to limit this disclosure. It is noted that although this disclosure has been described with reference to the foregoing aspects, modifications may be made to the technical solutions described in the foregoing aspects, or equivalent replacements may be made to some technical features in the technical solutions, provided that such modifications or replacements do not conflict with the technical solutions of the aspects of this disclosure.

What is claimed is:

1. A virtual camera calibration method, comprising:
obtaining a target object model of a physical camera device, the physical camera device including a camera and having an associated contact plane;
outputting for display, through a head-mounted display device to a user, the target object model with an operation controller, the contact plane of the target object model and a contact plane of the operation controller being in an attached state, and a camera position of the target object model corresponding to a camera position of the physical camera device;
based on the contact plane of the operation controller and the contact plane of the physical camera device being in the attached state, outputting for display through the head-mounted display device, an indication that a camera of the target object model and the camera of the physical camera device are in an overlapping state; and
calibrating a virtual camera based on spatial information of the operation controller and a spatial calibration operation for the virtual camera, the spatial information including target position information and a target orientation angle.

2. The method according to claim 1, further comprising:
obtaining the target object model from a locally stored model resource set based on a model invocation request, the model invocation request including model information of the physical camera device, the model resource set including at least one object model, each of the at least one object model corresponding to different model information, and the target object model corresponding to the model information included in the model invocation request.

3. The method according to claim 1, further comprising:
transmitting a model download request to a server based on a model invocation request, the model invocation request including model information of the physical camera device; and
receiving, from the server, the target object model corresponding to the model information included in the model invocation request.

4. The method according to claim 1, further comprising:
providing, through the head-mounted display device, a first prompt message instructing the user to attach the contact plane of the operation controller to the contact plane of the physical camera device and to align the target object model with the physical camera device.

5. The method according to claim 1, further comprising:
outputting for display through the head-mounted display device, a demonstration animation to guide a process of calibrating the virtual camera using the operation controller.

6. The method according to claim 1, wherein the calibrating the virtual camera comprises:
obtaining the target position information and a current orientation angle of the operation controller based on the spatial calibration operation for the virtual camera;
determining position information of the virtual camera based on the target position information and the camera position of the target object model;
determining the target orientation angle of the operation controller based on the current orientation angle and a plane normal vector of the operation controller, the plane normal vector being perpendicular to the contact plane of the operation controller; and
calibrating the virtual camera based on the determined position information and the target orientation angle.

7. The method according to claim 1, wherein, when the target object model corresponding to the physical camera device is not available, the method further comprises:
obtaining the target position information of the operation controller based on a position recording operation performed when the operation controller is in contact with the camera of the physical camera device;
obtaining the target orientation angle of the operation controller based on an angle recording operation performed when the contact plane of the operation controller is attached to the contact plane of the physical camera device; and
calibrating the virtual camera based on the target position information and the target orientation angle.

8. The method according to claim 7, further comprising:
providing, through the head-mounted display device, a second prompt message instructing the user to bring the operation controller into contact with the camera of the physical camera device.

9. The method according to claim 7, further comprising:
providing, through the head-mounted display device, a third prompt message instructing the user to attach the contact plane of the operation controller to the contact plane of the physical camera device.

10. The method according to claim 7, further comprising:
outputting for display, through the head-mounted display device, a second demonstration animation to guide a process of calibrating the virtual camera using the operation controller; and
obtaining, in response to completion of playback of the second demonstration animation, the target position information of the operation controller based on the position recording operation.

11. The method according to claim 7, wherein the obtaining the target orientation angle of the operation controller comprises:
obtaining a current orientation angle of the operation controller based on the angle recording operation; and
determining the target orientation angle based on the current orientation angle and a plane normal vector of the operation controller, the plane normal vector being perpendicular to the contact plane of the operation controller.

12. The method according to claim 1, wherein a plurality of pressure sensors are deployed on the contact plane of the operation controller, and the method further comprises:
obtaining at least one pressure parameter set from the plurality of pressure sensors, each of the at least one pressure parameter set including at least one pressure sensor detecting pressure; and
determining a contact state between the contact plane of the operation controller and the contact plane of the physical camera device based on the at least one pressure parameter set.

13. The method according to claim 1, further comprising:
enabling a passthrough function of the head-mounted display device based on a function enabling operation;
outputting for display, through the head-mounted display device based on the passthrough function, the target object model with the operation controller; and
outputting for display, through the head-mounted display device based on the passthrough function, an indication that the camera of the target object model and the camera of the physical camera device are in the overlapping state.

14. The method according to claim 1, further comprising:
outputting for display, through the head-mounted display device, a calibration prompt message prompting whether the virtual camera is to be calibrated;
based on a confirmation operation being performed in response to the calibration prompt message, calibrating the virtual camera using the target object model; and
based on a cancellation operation being performed in response to the calibration prompt message, calibrating the virtual camera based on historical spatial information of the operation controller, the historical spatial information including previously obtained spatial information of the operation controller.

15. The method according to claim 1, wherein
the physical camera device includes the camera and a camera base,
the camera is fixed to the camera base, and
the camera base is configured to attach to a detachable panel having a hollowed-out area through which the camera passes; and
the method further comprises:
determining that the contact plane of the operation controller and the contact plane of the physical camera device are in the attached state when the contact plane of the operation controller is attached to the detachable panel.

16. The method according to claim 1, wherein the virtual camera includes a foreground virtual camera and a background virtual camera; and
the method further comprises:
rendering a foreground space of a virtual scene using the foreground virtual camera to obtain a virtual foreground image;
rendering a background space of the virtual scene using the background virtual camera to obtain a virtual background image corresponding to the virtual foreground image; and
transmitting the virtual foreground image and the virtual background image to the physical camera device to enable the physical camera device to generate a composite recorded image based on the virtual foreground image, the virtual background image, and a matted image obtained by matting a real-world scene image captured by the physical camera device.

17. A virtual camera calibration apparatus, comprising:
processing circuitry configured to
obtain a target object model of a physical camera device, the physical camera device including a camera and having an associated contact plane;
output for display, through a head-mounted display device to a user, the target object model with an operation controller, the contact plane of the target object model and a contact plane of the operation controller being in an attached state, and a camera position of the target object model corresponding to a camera position of the physical camera device;
based on the contact plane of the operation controller and the contact plane of the physical camera device being in the attached state, output for display through the head-mounted display device, an indication that a camera of the target object model and the camera of the physical camera device are in an overlapping state; and
calibrate a virtual camera based on spatial information of the operation controller and a spatial calibration operation for the virtual camera, the spatial information including target position information and a target orientation angle.

18. The apparatus according to claim 17, wherein the processing circuitry is configured to:
obtain the target object model from a locally stored model resource set based on a model invocation request, the model invocation request including model information of the physical camera device, the model resource set including at least one object model, each of the at least one object model corresponding to different model information, and the target object model corresponding to the model information included in the model invocation request.

19. The apparatus according to claim 17, wherein the processing circuitry is configured to:
transmit a model download request to a server based on a model invocation request, the model invocation request including model information of the physical camera device; and
receive, from the server, the target object model corresponding to the model information included in the model invocation request.

20. A non-transitory computer-readable storage medium storing instructions which, when executed by a processor, cause the processor to perform:
obtaining a target object model of a physical camera device, the physical camera device including a camera and having an associated contact plane;
outputting for display, through a head-mounted display device to a user, the target object model with an operation controller, the contact plane of the target object model and a contact plane of the operation controller being in an attached state, and a camera position of the target object model corresponding to a camera position of the physical camera device;
based on the contact plane of the operation controller and the contact plane of the physical camera device being in the attached state, outputting for display through the head-mounted display device, an indication that a camera of the target object model and the camera of the physical camera device are in an overlapping state; and
calibrating a virtual camera based on spatial information of the operation controller and a spatial calibration operation for the virtual camera, the spatial information including target position information and a target orientation angle.
